(19) United States
(12) Patent Application Publication
(10) Pub. No.: US 2025/0194884 A1
(43) Pub. Date: Jun. 19, 2025

(54) MOVABLE ROBOT AND CONTROLLING METHOD THEREOF

(71) Applicant: Samsung Electronics Co., Ltd., Suwon-si (KR)

(72) Inventors: Heesuk YOON, Suwon-si (KR); Sanghyuk PARK, Suwon-si (KR); Kiyong LEE, Suwon-si (KR); Jusang LEE, Suwon-si (KR); Yeonkyu JEONG, Suwon-si (KR)

(73) Assignee: Samsung Electronics Co., Ltd., Suwon-si (KR)

(21) Appl. No.: 19/018,640

(22) Filed: Jan. 13, 2025

Related U.S. Application Data
(63) Continuation of application No. PCT/KR2024/017389, filed on Nov. 6, 2024.

(30) Foreign Application Priority Data
Dec. 15, 2023 (KR) 10-2023-0183389

(51) Int. Cl. A47L 11/40

(52) U.S. Cl. CPC A47L 11/4011; A47L 11/4008; A47L 11/4036

(57) ABSTRACT

A movable robot including a driver; and at least one processor configured to, when a preset event is identified during cleaning traveling of the movable robot, identify a target location stored in a memory for separating a cleaning pad from the movable robot, control the driver to move the movable robot to the identified target location based on spatial information stored in the memory, and control the movable robot to separate the cleaning pad from the movable robot at the identified target location, wherein the identified target location is determined based on at least one of the spatial information or user input.

### CROSS-REFERENCE TO RELATED APPLICATION

This application is a bypass continuation of International Application No. PCT/KR2024/017389, filed on Nov. 6, 2024, which is based on and claims priority to Korean Patent Application No. 10-2023-0183389, filed on Dec. 15, 2023, in the Korean Intellectual Property Office, the disclosures of which are incorporated by reference herein in their entireties.

### BACKGROUND

### 1. Field

The present disclosure relates to a movable robot and a controlling method thereof, and more particularly, to a movable robot that moves to a target location and performs a preset operation, and a controlling method thereof.

### 2. Description of Related Art

A movable robot may move not only to a user-specified destination but also to a pre-stored location. The movable robot may perform a specific function at a specific location. When a user manually sets a location to which he or she should move to perform a specific function, inconvenience may be caused.

When the movable robot does not automatically determine where a specific object (for example, a cleaning pad) should move, a user should set the location himself/herself. When the user sets the location himself/herself, the location may not be the optimal location.

When the location where the specific object should move is simply set in advance, there is a problem in that when a situation occurs where the location is no longer suitable, this cannot be reflected in real time.

For example, there may be a situation where another object is already placed in a preset location or it is impossible to move to the preset location. In this situation, there may be the inconvenience of requiring the user to re-set a specific location.

### SUMMARY

Embodiments of the present disclosure to provide a movable robot capable of automatically identifying a location to perform a specific function, and a controlling method thereof.

Aspects of embodiments of the disclosure will be set forth in part in the description which follows and, in part, will be apparent from the description, or may be learned by practice of the presented embodiments.

According to an embodiment of the disclosure, a movable robot includes a driver; and at least one processor configured to, when a preset event is identified during cleaning traveling of the movable robot, identify a target location stored in a memory for separating a cleaning pad from the movable robot, control the driver to move the movable robot to the identified target location based on spatial information stored in the memory, and control the movable robot to separate the cleaning pad from the movable robot at the identified target location, wherein the identified target location is determined based on at least one of the spatial information or user input.

According to an embodiment of the disclosure, the preset event may include at least one of an event in which a contamination level of the cleaning pad is identified as being greater than a threshold, an event in which a user command for replacing the cleaning pad is received, or an event in which the cleaning traveling is identified as being completed.

According to an embodiment of the disclosure, the identified target location may be determined based on sensing data and map data included in the spatial information. The at least one processor may acquire the sensing data through a sensing unit.

According to an embodiment of the disclosure, the sensing unit may include at least one of an ultrasonic sensor, a gyro sensor, an optical sensor, or an image sensor. The sensing data may include at least one of ultrasonic data, gyro data, optical data, or image data.

According to an embodiment of the disclosure, the identified target location may be determined based on object recognition information identified based on the image data.

According to an embodiment of the disclosure, the movable robot may further include a communication interface configured to connect to a first terminal device. The identified target location may be determined based on the user input received through a guide user interface (UI) provided by the first terminal device.

According to an embodiment of the disclosure, the preset event may be a preset event of a first group. The identified target location may be a first target location. When a preset event of a second group is identified while the movable robot is moving to the first target location, the at least one processor may be configured to identify a second target location stored in the memory that is different from the first target location, and control the driver to move the movable robot to the second target location based on the spatial information.

According to an embodiment of the disclosure, the preset event of the second group may include at least one of an event in which an obstacle is identified, an event identified as passing through a prohibited area to move the movable robot to the first target location, an event in which a separated cleaning pad is identified as being in the first target location, or an event in which remaining power of the movable robot is identified as being insufficient to move the movable robot to the first target location.

According to an embodiment of the disclosure, when the second target location that is different from the first target location is not identified, the at least one processor may be configured to control the driver to move the movable robot to a charging location based on the spatial information.

According to an embodiment of the disclosure, when the cleaning pad is separated from the movable robot at the identified target location, the at least one processor may be configured to provide a user interface (UI) for notifying that the cleaning pad is separated.

According to an embodiment of the disclosure, provided is a method of controlling a movable robot including a driver, the method including, when a preset event is identified during cleaning traveling of the movable robot, identifying a target location stored in a memory for separating a cleaning pad from the movable robot; controlling the driver to move the movable robot to the identified target location based on spatial information stored in the memory; and controlling the movable robot to separate the cleaning pad from the movable robot at the identified target location, wherein the identified target location is determined based on at least one of the spatial information or user input.

According to an embodiment of the disclosure, the preset event may include at least one of an event in which a contamination level of the cleaning pad is identified as being greater than a threshold, an event in which a user command for replacing the cleaning pad is received, or an event in which the cleaning traveling is identified as being completed.

According to an embodiment of the disclosure, the identified target location may be determined based on sensing data and map data included in the spatial information. The method may further include acquiring the sensing data through a sensing unit.

According to an embodiment of the disclosure, the sensing unit may include at least one of an ultrasonic sensor, a gyro sensor, an optical sensor, or an image sensor. The sensing data may include at least one of ultrasonic data, gyro data, optical data, or image data.

According to an embodiment of the disclosure, the identified target location may be determined based on object recognition information identified based on the image data.

According to an embodiment of the disclosure, the movable robot may be connected to a first terminal device, and the identified target location may be determined based on the user input received through a guide UI provided by the first terminal device.

According to an embodiment of the disclosure, the preset event may be a preset event of a first group, the identified target location may be a first target location, and the controlling method may further include identifying a second target location stored in the memory that is different from the first target location when a preset event of a second group is identified while the movable robot is moving to the first target location, and controlling the driver to move the movable robot to the second target location based on the spatial information.

According to an embodiment of the disclosure, the preset event of the second group may include at least one of an event in which an obstacle is identified, an event identified as passing through a prohibited area to move the movable robot to the first target location, an event in which a separated cleaning pad is identified as being in the first target location, or an event in which remaining power of the movable robot is identified as being insufficient to move the movable robot to the first target location.

According to an embodiment of the disclosure, when the second target location that is different from the first target location is not identified, the controlling method may further include moving the movable robot to a charging location based on the spatial information.

According to an embodiment of the disclosure, the controlling method may further include providing a UI for notifying that the cleaning pad is separated when the cleaning pad is separated from the movable robot at the identified target location.

### BRIEF DESCRIPTION OF THE DRAWINGS

These and/or other aspects of the disclosure will become apparent and more readily appreciated from the following description of embodiments, taken in conjunction with the accompanying drawings listed below.

FIG. 1 is a diagram for describing a movable robot for traveling in a specific space according to an embodiment of the disclosure.

FIG. 2 is a block diagram illustrating the movable robot according to an embodiment of the disclosure.

FIG. 3 is a block diagram for describing a specific configuration of the movable robot of FIG. 2 according to an embodiment of the disclosure.

FIG. 4 is a diagram for describing an operation of separating a pad according to an embodiment of the disclosure.

FIG. 5 is a diagram for describing an operation of storing a target location for performing a specific operation according to an embodiment of the disclosure.

FIG. 6 is a diagram for describing an operation of identifying a target location using spatial information according to an embodiment of the disclosure.

FIG. 7 is a diagram for describing coordinate axes according to an embodiment of the disclosure.

FIG. 8 is a diagram illustrating a table for calculating a target score according to an embodiment of the disclosure.

FIG. 9 is a diagram illustrating the table for calculating the target score according to an embodiment of the disclosure.

FIG. 10 is a diagram for describing an object recognition operation according to an embodiment of the disclosure.

FIG. 11 is a diagram for describing an operation of identifying a target location using a first terminal device according to an embodiment of the disclosure.

FIG. 12 is a diagram illustrating a guide screen for identifying the target location using the first terminal device according to an embodiment of the disclosure.

FIG. 13 is a diagram for describing an operation of identifying a target location using a second terminal device according to an embodiment of the disclosure.

FIG. 14 is a diagram for describing an example of identifying the target location using the second terminal device according to an embodiment of the disclosure.

FIG. 15 is a diagram for describing an operation of identifying the target location using the first terminal device and the second terminal device according to an embodiment of the disclosure.

FIG. 16 is a diagram for describing a guide screen of identifying the target location using the first terminal device and the second terminal device according to an embodiment of the disclosure.

FIG. 17 is a diagram illustrating an operation of a user to directly identify the target location through the first terminal device according to an embodiment of the disclosure.

FIG. 18 is a diagram illustrating a guide screen for a user to directly identify the target location through the first terminal device according to an embodiment of the disclosure.

FIG. 19 is a diagram for describing the operation of directly identifying the target location through the movable robot according to an embodiment of the disclosure.

FIG. 20 is a diagram for describing an example of directly identifying the target location through the movable robot according to an embodiment of the disclosure.

FIG. 21 is a diagram for describing an operation of separating a pad during cleaning traveling according to an embodiment of the disclosure.

FIG. 22 is a diagram for describing various operations of identifying the target location according to an embodiment of the disclosure.

FIG. 23 is a diagram for describing a screen that guides an operation of separating a pad according to an embodiment of the disclosure.

FIG. 24 is a diagram for describing a screen that guides an operation performed after separating the pad according to an embodiment of the disclosure.

FIG. 25 is a diagram for describing an operation of separating the pad during charging according to an embodiment of the disclosure.

FIG. 26 is a diagram illustrating an operation of returning to a charging location after separating the pad during charging the according to an embodiment of the disclosure.

FIG. 27 is a diagram for describing an example of returning to the charging location after separating the pad during the charging according to an embodiment of the disclosure.

FIG. 28 is a diagram for describing a controlling method of a movable robot according to an embodiment of the disclosure.

### DETAILED DESCRIPTION

It is to be understood that various embodiments of the present specification and terms used in these embodiments do not limit technical features described herein to specific embodiments, and include various modifications, equivalents, and/or substitutions of corresponding embodiments.

Throughout the drawings, similar or related components will be denoted by similar reference numerals.

A singular form of a noun corresponding to an item may include one or more of the item, unless the context clearly dictates otherwise.

In the present disclosure, each phrase such as “A or B,” “at least one of A and B,” “at least one of A or B,” “A, B, or C,” “at least one of A, B and C,” and “at least one of A, B, or C” may include any one of items listed together in the corresponding one of those phrases, or all possible combinations thereof. For example, the expression “at least one of A or B” may include, A, B, or A and B. The expression “at least one of A, B, or C” may include A, B, C, A and B, A and C, B and C, or A and B and C. The expression “at least one of A, B, C, or D” may include A, B, C, D, A and B, A and C, A and D, A and B and C, A and B and D, A and C and D, B and C, B and D, B and C and D, C and D, or A and B and C and D, and so on.

The terms “first”, “second”, or the like, may be used only to distinguish one component from the other components, and do not limit the corresponding components in other respects (e.g., importance or a sequence).

When any (e.g., first) component is referred to as “coupled” or “connected” to another (e.g., second) component with or without the term “functionally” or “communicatively”, it means that any component may be connected to another component directly (e.g., in a wired manner), wirelessly, or through a third component.

It will be understood that terms ‘include’ or ‘have’ used in the present disclosure, specify the presence of features, numerals, steps, operations, components, parts mentioned in the present specification, or a combination thereof, but do not preclude the presence or addition of one or more other features, numerals, steps, operations, components, parts, or a combination thereof.

When a component is “connected,” “coupled,” “supported,” or “contacted” with another component, this includes not only cases where the components are directly connected, coupled, supported, or contacted, but also cases where the components are indirectly connected, coupled, supported or contacted through a third component.

When a component is located “on” another component, this includes not only cases where a component is in contact with another component, but also cases where another component exists between the two components.

The term “and/or” includes a combination of a plurality of related described components or any one of the plurality of related described components.

Hereinafter, operating principles and embodiments of the present disclosure will be described with reference to the attached drawings.

A home appliance may include a communication module capable of communicating with other home appliances, user devices, or servers, a user interface that receives user input or outputs information to a user, at least one processor that controls an operation of the home appliance, and at least one memory that stores a program for controlling the operation of the home appliance.

The home appliance may be at least one of various types of home appliances. For example, as illustrated, the home appliance may include at least one of a refrigerator 11, a dishwasher 12, an electric range 13, an electric oven 14, an air conditioner 15, a clothes care machine 16, a washing machine 17, a dryer 18, or a microwave oven 19, but is not limited thereto, and may include, for example, various types of home appliances such as cleaning robots, vacuum cleaners, and televisions not illustrated in the drawings. In addition, the above-described home appliances are only examples, and in addition to the above-described home appliances, devices that may be connected to other home appliances, user devices, or servers and may perform the operations described later may be included in the home appliances according to an embodiment.

The server includes a communication module capable of communicating with other servers, home appliances or user devices, at least one processor capable of processing data received from other servers, home appliances or user devices, a program for processing data, or at least one memory capable of storing the processed data. The server may be implemented as various computing devices such as a workstation, a cloud, a data drive, and a data station. The server may be implemented as one or more servers physically or logically divided based on functions, detailed configurations of functions, data, etc., and may transmit and receive data and process the transmitted and received data through communication between each server.

The server may perform functions such as managing a user account, registering a home appliance by linking the home appliance to the user account, and managing or controlling the registered home appliance. For example, a user may connect to a server through a user device and generate the user account. The user account may be identified by an ID and a password set by the user. The server may register the home appliance to the user account according to established procedures. For example, the server may register, manage, and control the home appliance by linking identification information (e.g., serial number or MAC address) of the home appliance to the user account. The user device may include a communication module capable of communicating with the home appliance or the server, a user interface that receives user input or outputs information to a user, at least one processor that controls an operation of a user device, and at least one memory that stores a program for controlling the operation of the user device.

The user device may be carried by the user or arranged in the user's home or office. The user device may include, but is not limited to, a personal computer, a terminal, a portable telephone, a smart phone, a handheld device, a wearable device, etc.

A program, that is, an application, for controlling a home appliance may be stored in the memory of the user device. The application may be sold installed on the user device, or may be downloaded and installed from an external server.

By executing the application installed on the user device, the user may access the server to generate the user account, and communicate with the server based on the logged in user account to register the home appliances.

For example, when the home appliance operates so that it may access the server according to the procedure guided by the application installed on the user device, the home appliance may be registered in the user account by registering the identification information (e.g., serial number or MAC address, etc.) of the home appliance in the corresponding user account on the server.

The user may control the home appliance using the applications installed on the user device. For example, when the user logs in to the user account with the applications installed on the user device, the home appliance registered in the user account appears, and when the control command for the home appliance is entered, the control command may be transmitted to the home appliance through the server.

A network may include both wired and wireless networks. The wired network includes a cable network, a telephone network, etc., and the wireless network may include any network that transmits and receives signals through radio waves. The wired network and the wireless network may be connected to each other.

The network may include a wide area network (WAN) such as the Internet, a local area network (LAN) formed around an access point (AP), and a short-range wireless network that does not go through the access point (AP). The short-range wireless network may include Bluetooth™ (IEEE 802.15.1), Zigbee (IEEE 802.15.4), Wi-Fi Direct, near field communication (NFC), and Z-Wave, etc., but is not limited thereto.

The access point (AP) may connect the home appliance or the user device to the wide area network (WAN) to which the server is connected. The home appliance or the user device may be connected to the server through the wide area network (WAN).

The access point (AP) may communicate with the home appliance or the user device using the wireless communications such as Wi-Fi™ (IEEE 802.11), Bluetooth™ (IEEE 802.15.1), and Zigbee (IEEE 802.15.4), and access the wide area network (WAN) using the wired communication, but is not limited thereto.

According to various embodiments, the home appliance may be directly connected to the user device or server without passing through the access point (AP).

The home appliance may be connected to the user device or the server through a long-distance wireless network or a short-range wireless network.

For example, the home appliance may be connected to the user device through the short-range wireless network (e.g., Wi-Fi Direct).

As another example, the home appliance may be connected to the user device or the server through the wide area network (WAN) using the long-distance wireless network (e.g., a cellular communication module).

As another example, the home appliance may be connected to the wide area network (WAN) using the wired communication and be connected to the user device or the server through the wide area network (WAN).

When the home appliance may be connected to the wide area network (WAN) using the wired communication, it may operate as the access point. Accordingly, the access point (AP) may connect other home appliances to the wide area network (WAN) to which the server is connected. In addition, other home appliances may connect the home appliance to the wide area network (WAN) to which the server is connected.

The home appliance may transmit information about its operation or status to other home appliances, user devices, or servers through the network. For example, when receiving requests from the servers, the home appliance may transmit information about its operation or status to other home appliances, user devices, or servers when a specific event occurs in the home appliance or periodically or in real time. When the information about the operation or status of the home appliance is received, the server may update the stored information about the operation or status of the home appliance and transmit the updated information about the operation and status of the home appliance to the user device through the network. Here, updating the information may include various operations that change the existing information, such as an operation of adding new information to the existing information or an operation of replacing the existing information with new information.

The home appliance may acquire various types of information from other home appliances, user devices, or servers, and provide the acquired information to the user. For example, the home appliance may acquire information (e.g., recipes, laundry methods, etc.) related to the function of the home appliance and various types of environmental information (e.g., weather, temperature, humidity, etc.) from the server, and provide information acquired through a user interface.

The home appliance may operate according to control commands received from other home appliances, user devices, or servers. For example, when the home appliance acquires prior approval from the user so that it may operate according to the control command from the server even if there is no user input, the home appliance may operate according to the control command received from the server. Here, the control command received from the server may include, but is not limited to, a control command input by the user through the user device, a control command based on preset conditions, etc.

The user device may transmit the information about the user to the home appliance or the server through a communication module. For example, the user device may transmit information about a user's location, a user's health status, a user's preference, a user's schedule, etc., to the server. The user device may transmit the information about the user to the server according to the user's prior approval.

The home appliance, the user device, or the server may determine the control commands using technologies such as artificial intelligence. For example, the server may receive the information about the operation or status of the home appliance or receive the information about the user of the user device, process the information using the technology such as the artificial intelligence, and transmit the processed results or control commands to the home appliance or the user device based on the processed results.

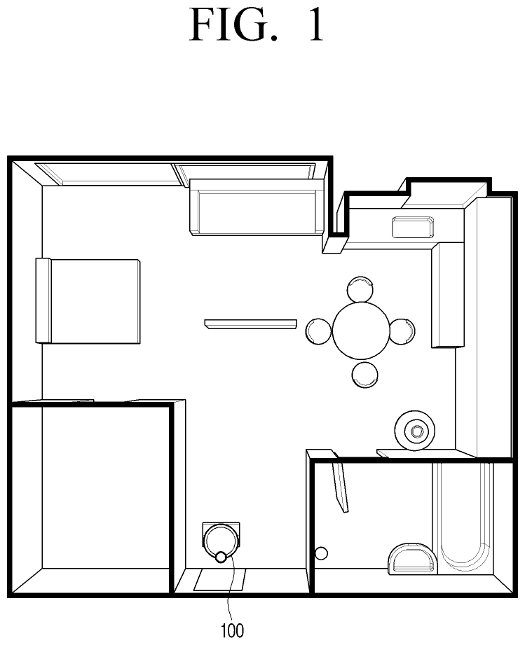

FIG. 1 is a diagram for describing a movable robot 100 for traveling in a specific space according to an embodiment.

The movable robot 100 may travel in a specific space. The movable robot 100 may refer to a movable device. For example, the movable robot 100 may be a robot vacuum cleaner, a service robot, etc.

The movable robot 100 may travel in a space set by the user or in a space automatically recognized. For example, the movable robot 100 may travel in a specific space to perform a cleaning function. The movable robot 100 may attach a cleaning pad to perform the cleaning function. When the cleaning pad becomes dirty, there is a need to replace the cleaning pad.

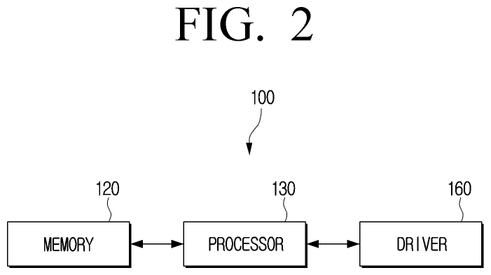

The movable robot 100 may move to a specific location (target location) to discard the cleaning pad. The operation of identifying the location target is described in FIG. 2.

FIG. 2 is a block diagram illustrating the movable robot 100 according to an embodiment.

Referring to FIG. 2, the movable robot 100 may include at least one of a memory 120, at least one processor 130, and a driver 160.

The movable robot 100 may refer to a movable electronic device or an electronic device for controlling a movable device. For example, the movable robot 100 may refer to a movable robot capable of traveling or a device for controlling a movable robot. The movable robot 100 may be a server that performs analysis operations to control the traveling of the device.

According to various embodiments, the movable robot 100 may be a mobile cleaning robot that performs a cleaning operation.

A sensor unit 110 may sense sensing data.

The memory 120 may store the sensing data or processed sensing data. The memory 120 may store at least one instruction.

At least one processor 130 may perform overall control operations of the movable robot (or electronic device). Specifically, at least one processor 130 functions to control the overall operation of the movable robot (or electronic device). At least one processor 130 may be connected to the memory 120 to control the movable robot 100.

The memory 120 may store spatial information and a target location for separating the cleaning pad.

The spatial information may include various types information related to the space in which the movable robot 100 travels. The spatial information may include at least one of the sensing data sensed in the traveling space or map data representing the traveling space.

The sensing data may include data sensed while the movable robot 100 is traveling.

The map data may include coordinate data of the space in which the movable robot 100 travels or feature data corresponding to each coordinate data. The coordinate data may be information representing a specific location. The feature data may be information indicating characteristics of each coordinate.

The movable robot 100 may travel based on the map data. At least one processor 130 may identify a movement path of the movable robot 100 based on coordinate data included in the map data.

The driver 160 may control a physical force for the movable robot 100 to move. The driver 160 may control operations related to the movement of the movable robot 100.

When a preset event is identified during cleaning traveling, at least one processor 130 may identify the target location, control the driver 160 to move to the target location based on the spatial information, and separate the cleaning pad from the target location, and the target location may be determined based on at least one of the spatial information or the user input.

The cleaning traveling may be described as a function that performs cleaning. At least one processor 130 may identify whether a preset event of a first group has occurred during the cleaning traveling. The preset event of the first group may be described as the preset event included in the first group.

The preset event (first group) may include at least one of an event in which a contamination level of the cleaning pad is identified as being equal to or greater than a threshold, an event in which a user command for replacing the cleaning pad is received, or an event in which the cleaning traveling is identified as being completed.

When the preset event included in the first group is identified, at least one processor 130 may perform a function for separating the cleaning pad (cleaning pad separation function). At least one processor 130 may identify a target location where the cleaning pad is to be separated.

As an example, the target location may be pre-stored in the memory 120. The target location may be pre-stored in the memory 120 before starting the cleaning traveling. When the preset event included in the first group is identified, at least one processor 130 may identify (or call) the target location stored in the memory 120.

For example, when the preset event included in the first group is identified, at least one processor 130 may newly identify the target location.

The operation of identifying the target location may vary.

According to an embodiment, the target location may be determined based on spatial information.

The target location may be determined based on the sensing data and map data included in the spatial information.

The target location may be determined through a target score. The target score may be a score that quantifies whether the location is suitable for discarding the cleaning pad. The target score may be acquired based on table information. The table information may be described as a data-target score mapping table for calculating the target score. The table information may be described as target score table information, score lookup table information, etc.

A first target score may be acquired based on the sensing data and a table corresponding to the sensing data. A second target score may be acquired based on the map data and a table corresponding to the map data. A final target location may be determined based on at least one of the first target score or the second target score.

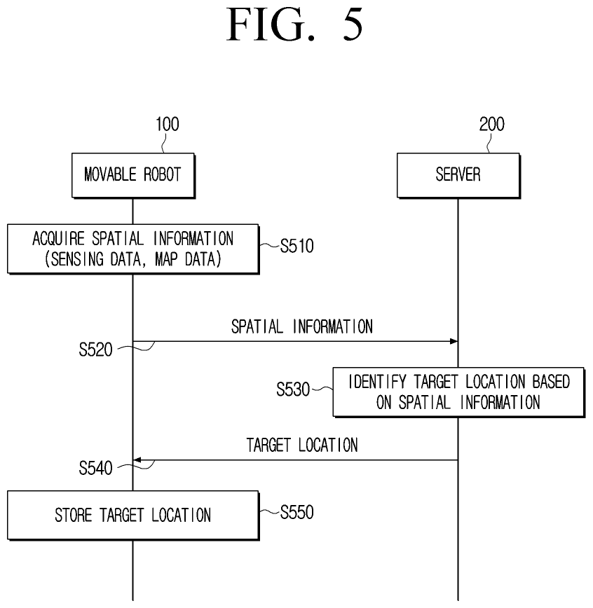

The operation of identifying the target location based on the spatial information is described in FIGS. 5 to 10.

At least one processor 130 may acquire the sensing data through the sensing unit 110.

The sensing unit 110 includes at least one of an ultrasonic sensor, a gyro sensor, an optical sensor, and an image sensor. The optical sensor may include at least one of an infrared sensor and a lidar sensor. The image sensor may include a camera.

According to various embodiments, the sensing unit 110 may additionally include a distance sensor. The distance sensor may include at least one of a 2D sensor, a 3D sensor, and a Time of Flight (ToF) sensor.

The sensing data may include at least one of ultrasonic data, gyro data, optical data, and image data.

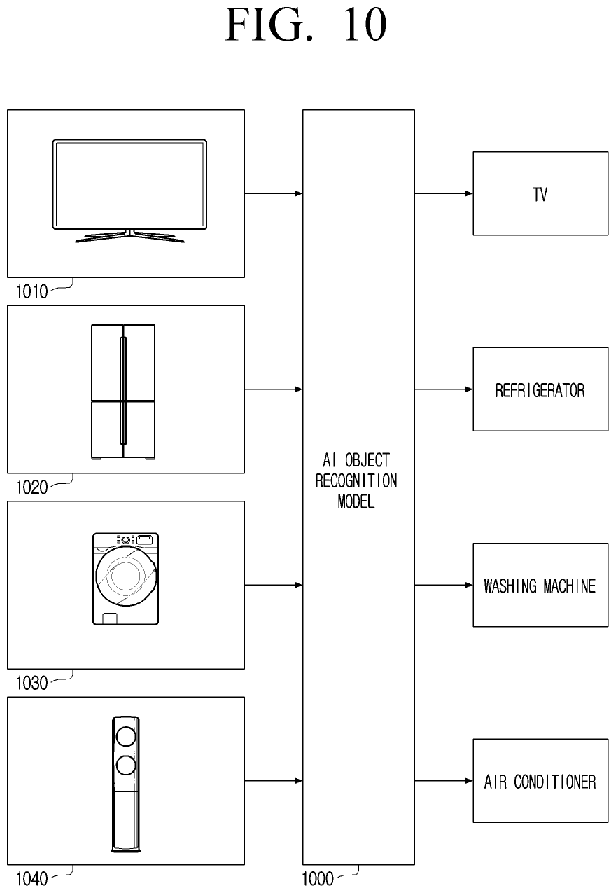

The target location may be determined based on object recognition information identified based on image data. The operation of acquiring the object recognition information is described in FIG. 10.

According to an embodiment, the target location may be determined based on the user input.

The movable robot 100 may further include a communication interface 140 for connection to a first terminal device 300-1.

The target location may be determined based on the user input received through a guide UI provided by the first terminal device 300-1.

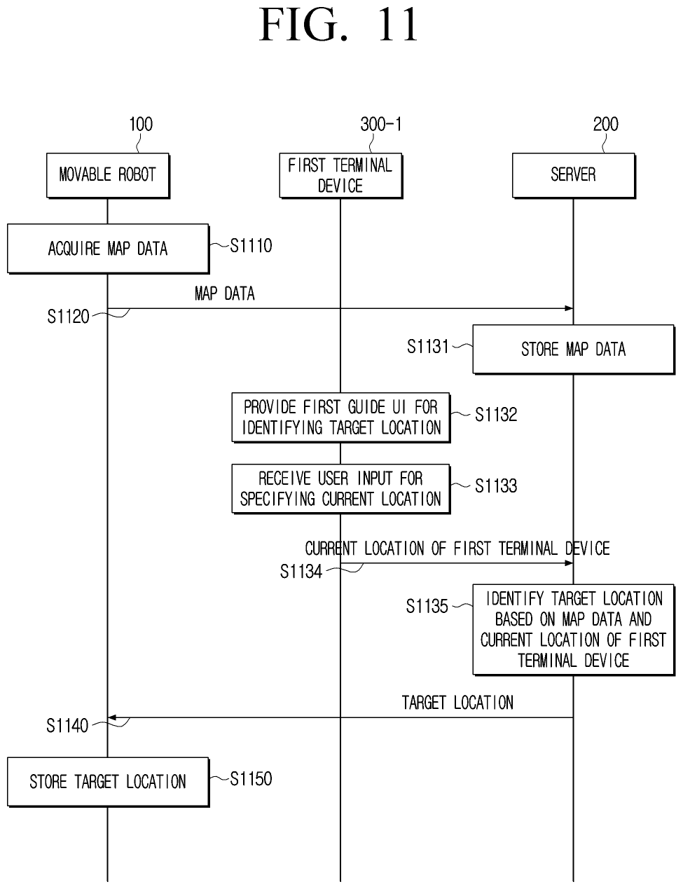

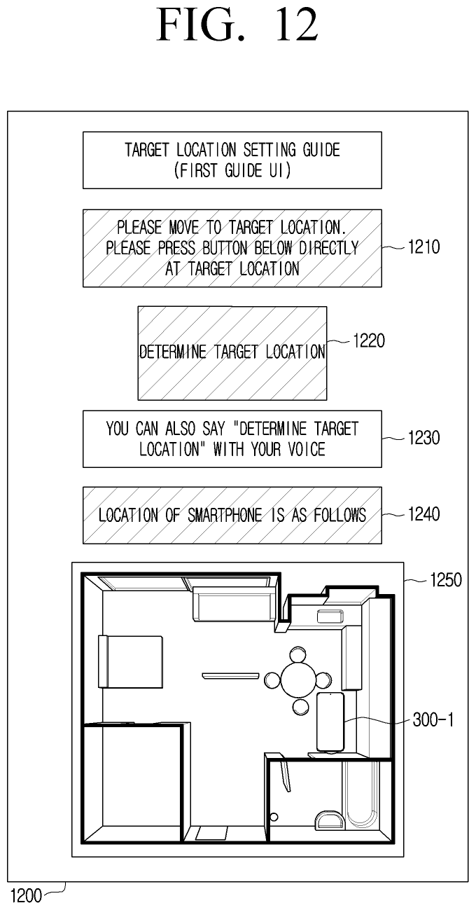

As an example, the first terminal device 300-1 may provide a UI that guides the user input after moving the first terminal device 300-1 to the target location. This will be described with reference to FIGS. 11 and 12.

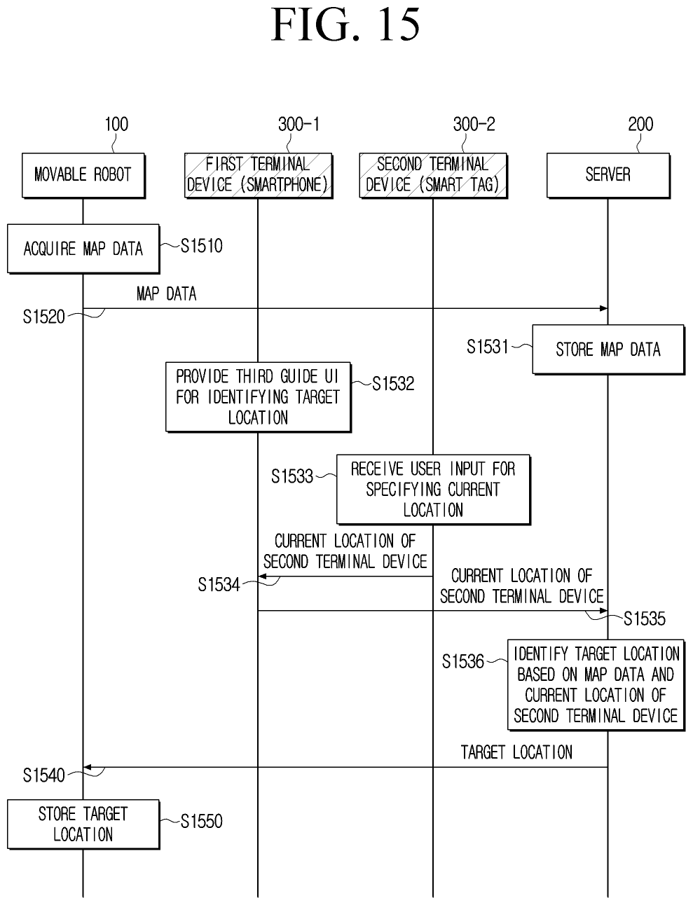

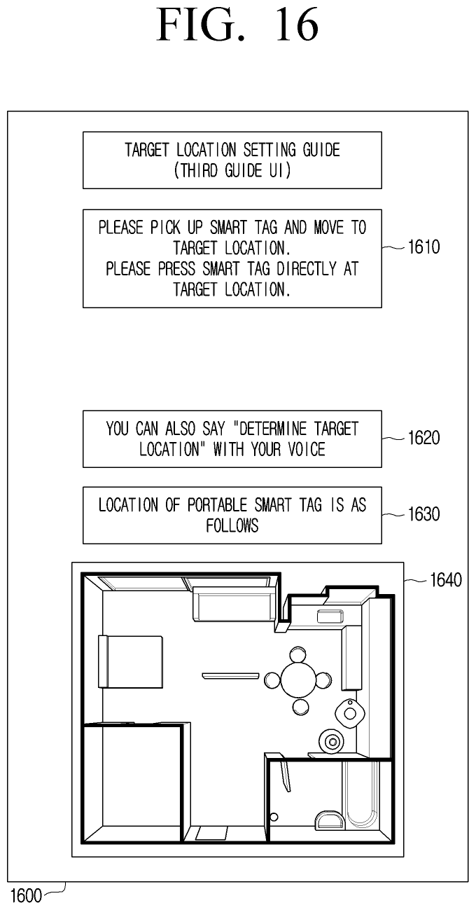

As an example, the first terminal device 300-1 may provide a UI that guides the user input after moving a second terminal device 300-2 to the target location. This will be described with reference to FIGS. 15 and 16.

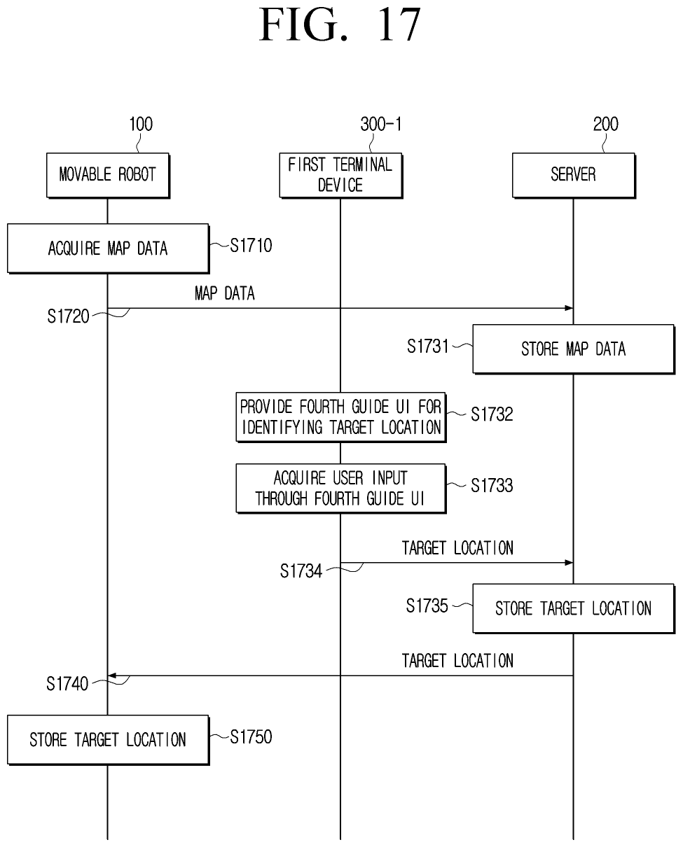

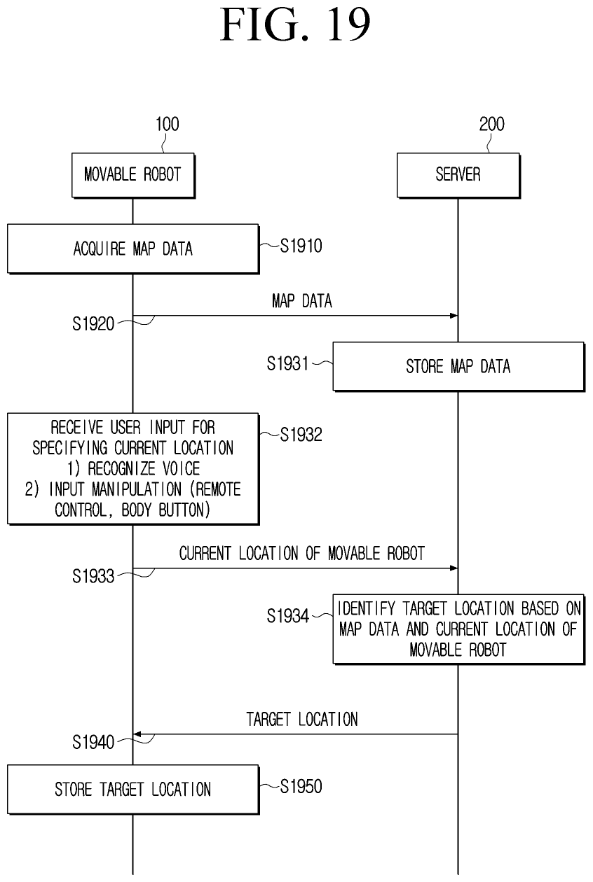

As an example, the first terminal device 300-1 may provide the UI for determining the target location without the user moving to the target location. This will be described with reference to FIGS. 17 and 19.

There may be a plurality of target locations. There may be a plurality of target locations for separating the cleaning pad. The plurality of target locations may include priority. For example, there may be a first target location of first priority and a second target location of second priority.

When a preset event of a second group is identified while moving to the target location, at least one processor 130 may control the driver 160 to identify a second target location that is different from the first target location and move to the second target location based on the spatial information.

The preset event of the second group may include at least one of an event in which an obstacle is identified, an event identified as passing through a prohibited area to move to the first target location, an event in which a separated cleaning pad is identified as being in the first target location, and an event in which remaining power is identified as being insufficient to move to the first target location.

When the second target location that is different from the first target location is not identified, at least one processor 130 may control the driver 160 to move to a charging location based on the spatial information.

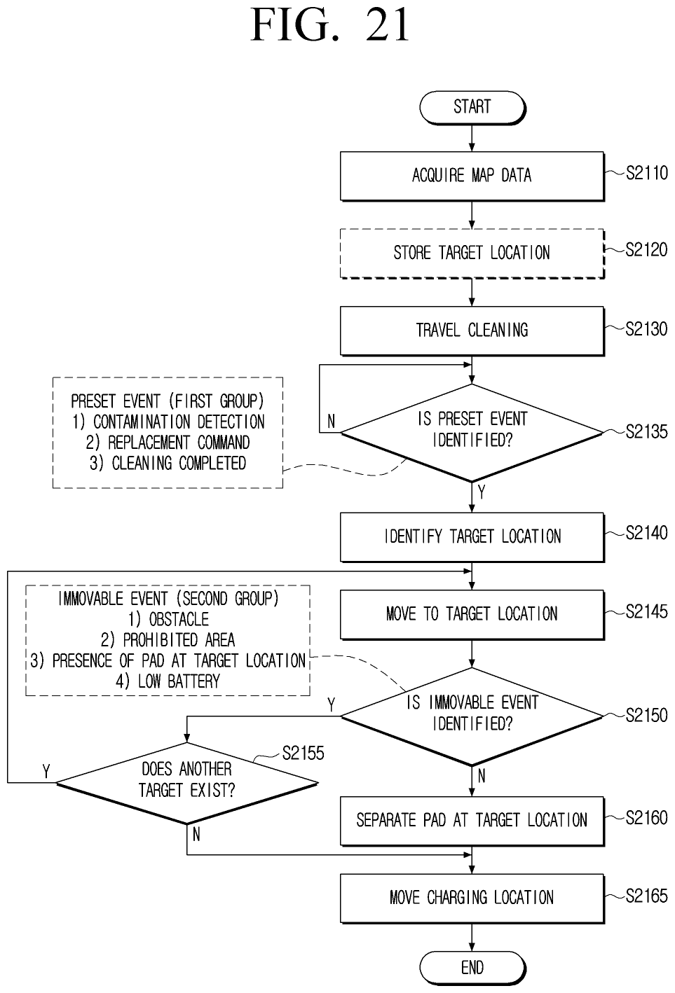

Detailed descriptions related to the preset events of the first group, the preset events of the second group, and the movement of the charging location are described with reference to FIG. 21.

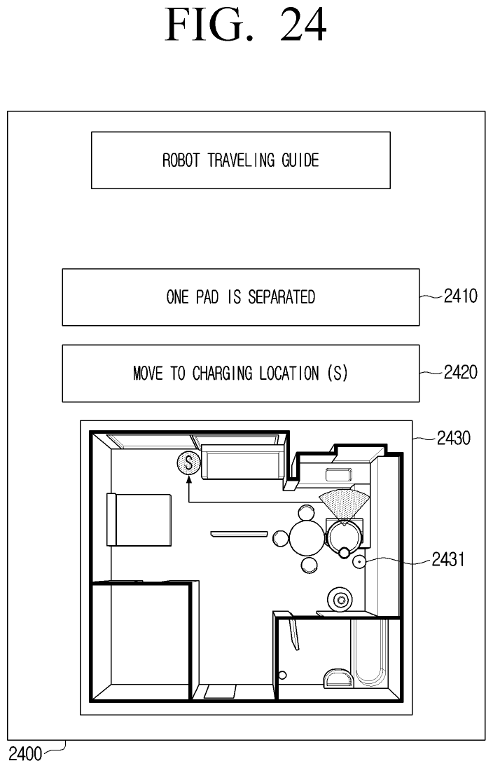

When the cleaning pad is separated from the target location, at least one processor 130 may provide a UI to notify that the cleaning pad is separated. A description related thereto will be made with reference to FIG. 24.

FIGS. 5 to 20 below describe an embodiment in which the target location is determined through a server 200.

According to various embodiments, the operations of the server 200 described in FIGS. 5 to 20 may be performed directly in the movable robot 100. As in the on-device embodiment, the operations of the server 200 described in FIGS. 5 to 20 may be replaced with those performed by the movable robot 100 or at least one processor 130.

In FIGS. 5 to 20, the movable robot 100 is described as receiving the target location through the server 200. According to the implementation example, the movable robot 100 may receive the target location through the charging station corresponding to the movable robot 100. The movable robot 100 may also use a charging station when communicating with the server 200. The charging station may be used as an access point (AP) device.

According to various embodiments, at least one processor 130 may update the target location. At least one processor 130 may update the target location when the map data is updated. Even if the target location is pre-stored, at least one processor 130 may identify the target location again when the map data is updated. This is because the sensing data and the map data may change. For example, when only information about a first space is stored, the movable robot 100 may search for a second space that is different from the first space. When the information (sensing data, map data) about the second space is received, at least one processor 130 may identify the target location using both the existing information and the newly acquired information about the second space.

According to various embodiments, at least one processor 130 may update the target location based on the discarded pad. The target location information may include the target location and priority corresponding to the target location. When the at least one processor 130 completes the operation of separating the cleaning pad, the target location information may be updated.

When the cleaning pad is separated from the first target location, the first target location may no longer be a suitable location for separating the cleaning pad. Accordingly, at least one processor 130 may control the movable robot 100 to discard the cleaning pad at the second target location that is different from the existing first target location.

For example, it is assumed that the first target location of the first priority and the second target location of the second priority are included in the target location information. It is assumed that the movable robot 100 has separated the cleaning pad from the first target location. When the cleaning pad is separated from the first target location, at least one processor 130 may update the target location information by changing the first target location to second priority and the second target location to first priority.

At least one processor 130 may determine whether the cleaning pad separated from the first target location has been removed by the user. At least one processor 130 may re-update the target location information when the cleaning pad separated from the first target location has been removed. At least one processor 130 may change the first target location, which had been changed to the second priority, back to the first priority, and change the second target location, which had been changed to the first priority, back to the second priority.

At least one processor 130 may update the target location information while charging. While charging, it may be difficult to get to the target location to replace the cleaning pad. The battery may run out while traveling to the target location, or the charging may be more important to the user than replacing the cleaning pad. At least one processor 130 may change the target location and the priority information of the target location while charging.

It is assumed that there is one target location. It is assumed that one target location is more than a critical distance away from the charging location. At least one processor 130 may newly identify the target location within the critical distance from the charging location while charging.

It is assumed that there are a plurality of target locations. At least one processor 130 may assign the highest priority to the target location closest to the charging location while charging. When all of the plurality of target locations are more than the critical distance away from the charging location, at least one processor 130 may newly identify the target location within the critical distance from the charging location.

When the cleaning pad is separated from the location target, at least one processor 130 may control the movable robot 100 to attach a new cleaning pad.

As an example, at least one processor 130 may provide a UI to guide the attachment of the cleaning pad. A notification guiding the attachment of a new cleaning pad may be output through a speaker of the movable robot 100. A screen including the notification guiding the attachment of a new cleaning pad may be displayed through the first terminal device 300-1.

As an example, at least one processor 130 may automatically attach the cleaning pad. A function of automatically replacing a new cleaning pad may be performed at the charging station corresponding to the movable robot 100. At least one processor 130 may control the driver 160 to move to the charging location (or cleaning pad replacement location). At least one processor 130 may transmit a new cleaning pad replacement command to the charging station after arriving at the charging location.

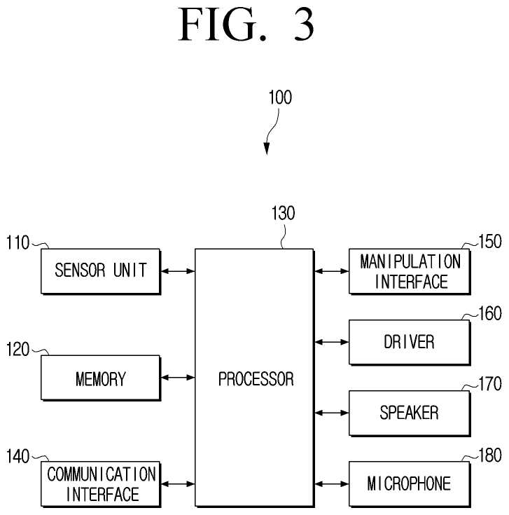

FIG. 3 is a block diagram for describing a specific configuration of the movable robot 100 of FIG. 2 according to an embodiment.

Referring to FIG. 3, the movable robot 100 may include at least one of the sensor unit 110, the memory 120, the at least one processor 130, the communication interface 140, a manipulation interface 150, the driver 160, a speaker 170, or a microphone 180. Description of parts that overlap with the configuration described in FIG. 2 will be omitted.

The sensor part 110 may include at least one sensor. At least one sensor may be one of a lidar sensor that senses a location, an image sensor that captures an image, or an acceleration sensor (or gyro sensor) that senses a rotation angle. According to various embodiments, one sensor may sense all of the location, image, rotation angle, etc. The sensor unit 110 may sense sensing data.

The sensor unit 110 includes a first sensor unit and a second sensor unit, and at least one processor 130 may acquire a plurality of traveling locations through the first sensor unit and acquire a plurality of captured images through the second sensor unit.

The first sensor unit may be a sensor that acquires sensing data about the surrounding environment. The first sensor unit may be a lidar sensor, an infraRed (IR) sensor, a 3D depth camera, a 3D visual sensor, etc. At least one processor 130 may acquire the traveling location of the movable robot 100 based on the sensing data acquired from the first sensor unit.

The number of the first sensor unit may be described as 110-1 and the number of the second sensor unit may be described as 110-2.

The second sensor unit may be an image sensor. The image sensor may include a camera. At least one processor 130 may acquire the captured image around the movable robot 100 based on the sensing data acquired from the second sensor unit.

The memory 120 may be implemented as an internal memory such as a read-only memory (ROM) (e.g., an electrically erasable programmable read-only memory (EEPROM)), a random access memory (RAM), or the like, included in the processor 130 or be implemented as a memory separate from the processor 130. In this case, the memory 120 may be implemented in the form of a memory embedded in the movable robot 100 or the form of a memory attachable to and detachable from the movable robot 100, depending on the data storing purpose. For example, data for driving the movable robot 100 may be stored in the memory embedded in the movable robot 100, and data for an extension function of the movable robot 100 may be stored in the memory attachable to and detachable from the movable robot 100.

Meanwhile, the memory embedded in the movable robot 100 may be implemented as at least one of a volatile memory (for example, a dynamic RAM (DRAM), a static RAM (SRAM), a synchronous dynamic RAM (SDRAM), or the like) or a non-volatile memory (for example, a one-time programmable ROM (OTPROM), a programmable ROM (PROM), an erasable and programmable ROM (EPROM), an electrically erasable and programmable ROM (EEPROM), a mask ROM, a flash ROM, a flash memory (for example, a NAND flash, a NOR flash or the like)), a hard drive, or a solid state drive (SSD)), and the memory attachable to and detachable from the movable robot 100 may be implemented in the form such as a memory card (for example, a compact flash (CF), a secure digital (SD), a micro-SD, a mini-SD, an extreme digital (xD), a multi-media card (MMC), or the like), an external memory (for example, a universal serial bus (USB) memory) connectable to a USB port, or the like.

The processor 130 may be implemented as a digital signal processor (DSP), a microprocessor, or a time controller (TCON) processing a digital signal. However, the processor 130 is not limited thereto, and may include one or more of a central processing unit (CPU), a micro controller unit (MCU), a micro processing unit (MPU), a controller, an application processor (AP), a graphics processing unit (GPU) or a communication processor (CP), or an advanced reduced instruction set computer (RISC) machines (ARM) processor, or may be defined by these terms. The processor 130 may be implemented by a system-on-chip (SoC) or a large scale integration (LSI) in which a processing algorithm is embedded, or may be implemented in a field programmable gate array (FPGA) form. The processor 130 may perform various functions by executing computer executable instructions stored in the memory.

The communication interface 140 is a component performing communication with various types of external apparatuses depending on various types of communication manners. The communication interface 140 may include a wireless communication module or a wired communication module. Each communication module may be implemented in the form of at least one hardware chip.

The wireless communication module may be a module that communicates wirelessly with an external device. For example, the wireless communication module may include at least one of a Wi-Fi module, a Bluetooth module, an infrared communication module, or other communication modules.

The Wi-Fi module and the Bluetooth module perform communication in a Wi-Fi method and a Bluetooth method, respectively. When the Wi-Fi module or the Bluetooth module is used, various connection information such as a service set identifier (SSID), a session key, and the like, is first transmitted and received, communication is connected using the connection information, and various information may then be transmitted and received.

The infrared communication module performs communication according to an infrared data association (IrDA) technology of wirelessly transmitting data to a short distance using an infrared ray positioned between a visible ray and a millimeter wave.

Other wireless communication modules may include at least one communication chip performing communication according to various wireless communication standards such as Zigbee, 3^{rd} generation (3G), 3^{rd} generation partnership project (3GPP), long term evolution (LTE), LTE advanced (LTE-A), 4^{th} generation (4G), 5^{th} generation (5G), and the like, in addition to the communication manner described above.

The wired communication module may be a module that communicates with an external device in a wired manner. For example, the wired communication module may include at least one of a local area network (LAN) module, an Ethernet module, a pair cable, a coaxial cable, an optical fiber cable, or an ultra wide-band (UWB) module.

The manipulation interface 150 may be implemented as a device such as a button, a touch pad, a mouse, and a keyboard or may be implemented as a touch screen that may perform both of the abovementioned display function and manipulation input function. The button may be various types of buttons such as a mechanical button, a touch pad, a wheel, and the like, formed in any region such as a front surface portion, a side surface portion, a rear surface portion, and the like, of a body appearance of the movable robot 100.

The driver 160 may be a component that generates and transmits physical force that controls the traveling of the movable robot 100. The driver 160 may include a motor.

The speaker 170 is a component outputting various notification sounds, a voice message, or the like, as well as various audio data.

The movable robot 100 may include the microphone 180.

The microphone 180 is a component for receiving a user's voice or other sounds and converting the user's voice or other sounds into audio data. The microphone 180 may receive the user voice in an activated state. For example, the microphone 180 may be formed integrally with the movable robot 100 in upper, front, side directions, or the like. The microphone 180 may include various components such as a microphone collecting a user voice having an analog form, an amplifying circuit amplifying the collected user voice, an A/D converting circuit sampling the amplified user voice to convert the amplified user voice into a digital signal, a filter circuit removing a noise component from the converted digital signal, and the like.

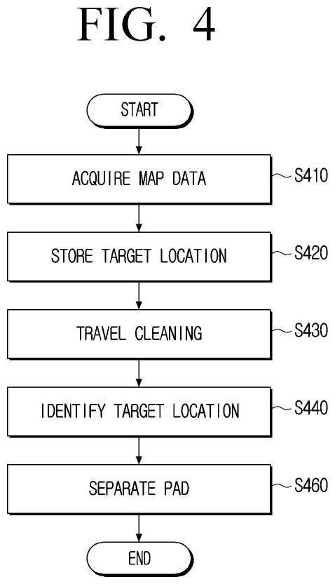

FIG. 4 is a diagram for describing an operation of separating a cleaning pad according to an embodiment.

Referring to FIG. 4, the movable robot 100 may acquire map data (S410). The map data may include information about the target space for the movable robot 100 to travel. The map data may include location information or coordinate information necessary for the movable robot 100 to travel. The map data may be described as map information, etc.

The movable robot 100 may store the target location (S420). The target location may indicate a designated location to perform a specific action. The target location may indicate a target location for moving a preset object. As an example, the preset object may be the cleaning pad attached to the movable robot 100. As an example, the preset object may be an obstacle that the movable robot 100 wants to move. The target location may be described as target coordinates, a destination, etc.

According to an embodiment, the target location may be a location determined based on at least one of the sensing data or the map data. This will be described with reference to FIGS. 5 and 10.

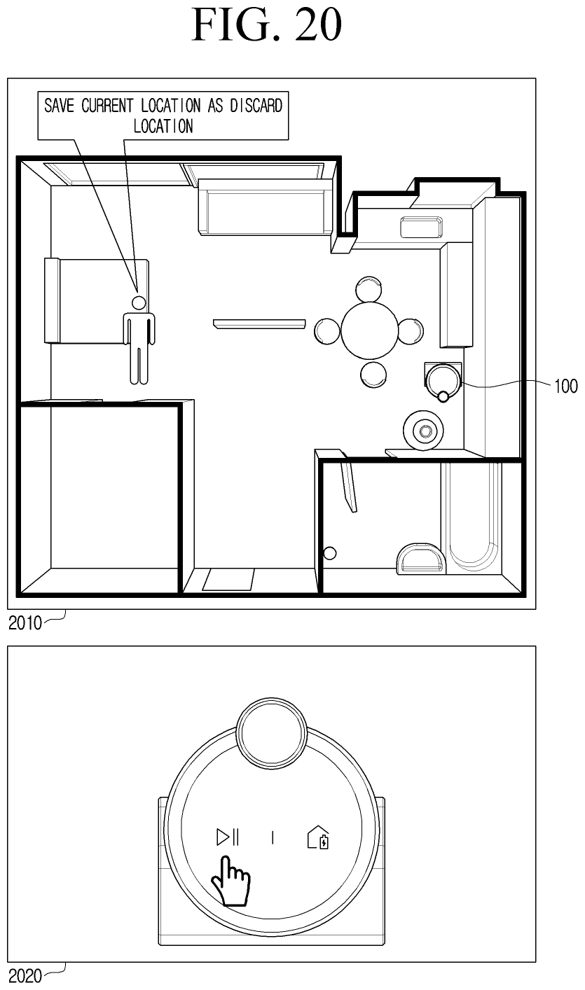

According to an embodiment, the target location may be determined based on the user input. This will be described with reference to FIGS. 11 and 20.

According to an embodiment, the target location may be a preset location. The target location may be a location set within a critical range of a charging location.

The movable robot 100 may perform the cleaning traveling (S430). The cleaning traveling may refer to an operation of traveling for cleaning. The movable robot 100 may perform the cleaning traveling based on the user commands.

The movable robot 100 may identify the target location after starting the cleaning traveling (S440). For example, the movable robot 100 may identify the target location when the preset event is identified after starting the cleaning traveling. This will be described in detail with reference to FIG. 21.

The movable robot 100 may separate the cleaning pad after identifying the target location (S460). The movable robot 100 may separate the cleaning pad from the target location. When the movable robot 100 may not separate the cleaning pad from the target location, the movable robot 100 may identify another target location and separate the cleaning pad from another target location.

FIG. 5 is a diagram for describing an operation of storing a target location for performing a specific operation according to an embodiment.

Referring to FIG. 5, the movable robot 100 may acquire the spatial information (S510). The spatial information may include at least one of the sensing data or the map data. The sensing data may indicate the sensing data acquired through various sensors. The sensing data may be data acquired in the space where the movable robot 100 travels. The sensing data may be information indicating characteristics corresponding to a specific location. The sensing data may include information on a specific location and information to which data sensed at the specific location is mapped. For example, the sensing data may include first sensing data sensed at a first location and second sensing data sensed at a second location. The first sensing data may include the location where the sensing data was sensed in addition to the sensing data itself.

The map data may include information about the space for the movable robot 100 to travel. The map data may include information about the entire space for the movable robot 100 to travel. The map data may include at least one of coordinate data or feature data. The coordinate data may indicate location data to indicate space. The feature data may be data corresponding to the coordinate data. For example, there may be first feature data corresponding to a first location, and second feature data corresponding to a second location. The feature data may be data corresponding to a specific location. The feature data may be described as characteristic data or description data.

The movable robot 100 may transmit the spatial information to the server 200 (S520).

The server 200 may receive the spatial information from the movable robot 100. The server 200 may identify the target location based on the spatial information (S530). The server 200 may acquire at least one of the sensing data or the map data included in the spatial information. The server 200 may identify the target location for discarding the cleaning pad. The server 200 may transmit the identified target location to the movable robot 100 (S540).

The movable robot 100 may receive the target location from the server 200. The movable robot 100 may store the received target location (S550).

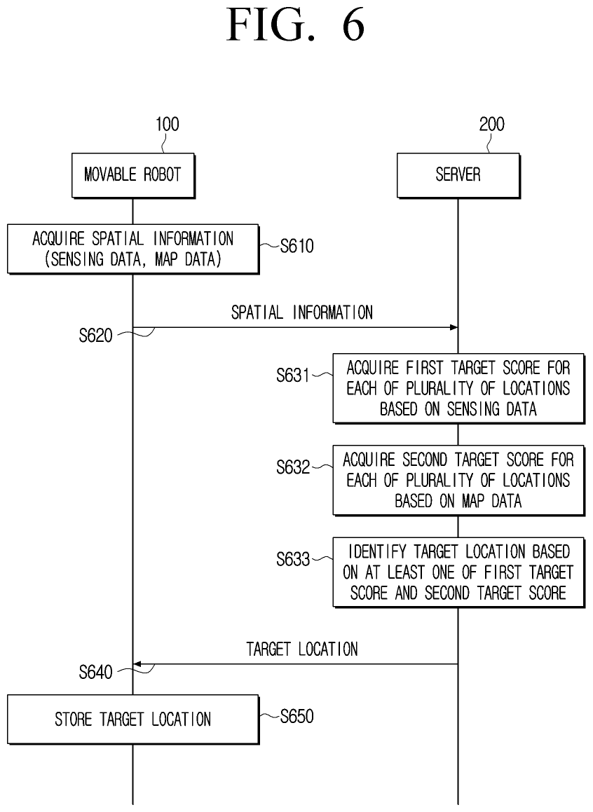

FIG. 6 is a diagram for describing an operation of identifying a target location using spatial information according to an embodiment.

Steps S610, S620, S640, and S650 in FIG. 6 may correspond to steps S510, S520, S540, and S550 in FIG. 5. Redundant descriptions will be omitted.

Upon receiving the spatial information, the server 200 may acquire the first target scores for each of the plurality of locations based on the sensing data (S631). The server 200 may analyze the sensing data to acquire the first target scores for each of the plurality of locations.

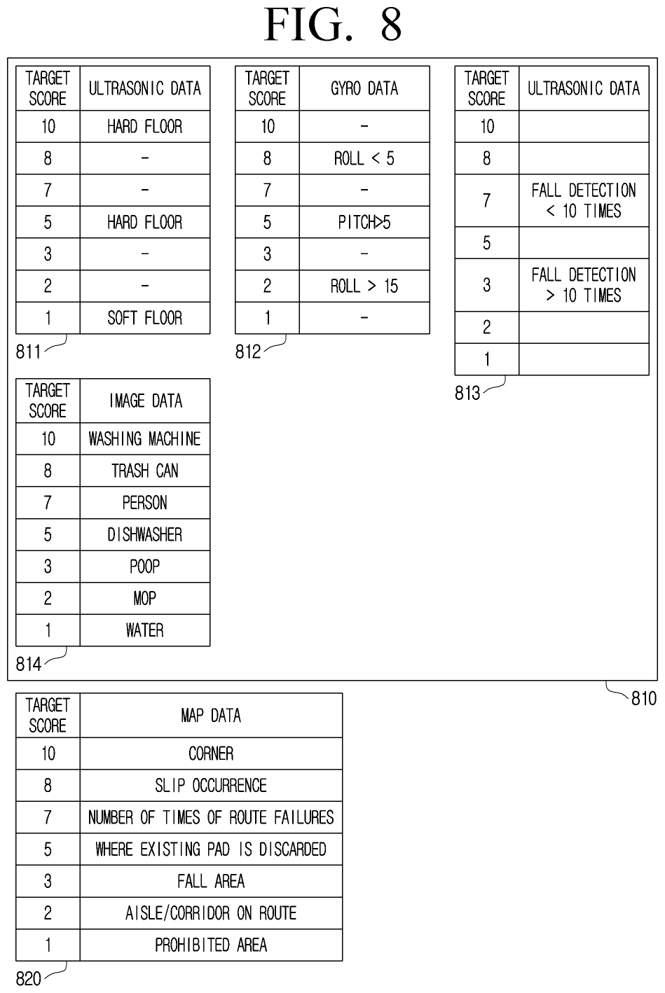

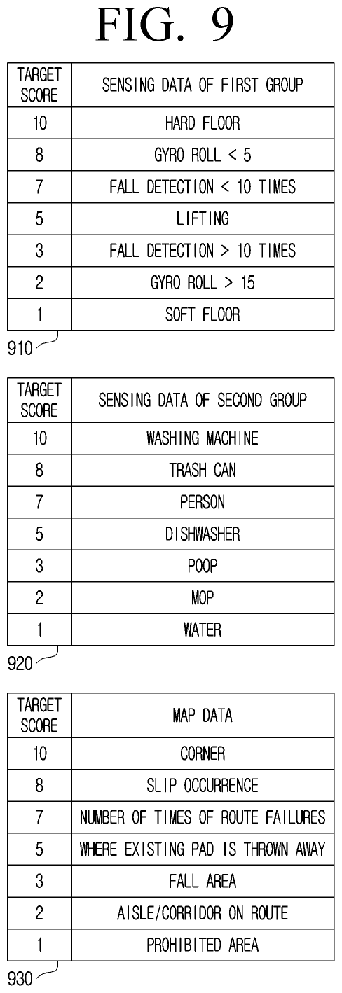

For example, the server 200 may acquire the first target score corresponding to the first location based on the first sensing data corresponding to the first location and table information. The server 200 may acquire the first target score corresponding to the second location based on the second sensing data corresponding to the second location and the table information. Descriptions related to the table information are made with reference to FIGS. 8 and 9.

The first target score may be described as a first type of target score or a first type of sub-score. Since there are the first target scores corresponding to each location, the first target score may include a plurality of concepts.

The server 200 may acquire second target scores for each plurality of locations based on the map data (S632).

Upon receiving the spatial information, the server 200 may acquire the second target scores for each of the plurality of locations based on the map data (S632). The server 200 may analyze the map data to acquire the second target scores for each of the plurality of locations.

For example, the server 200 may acquire the second target score corresponding to the first location based on the first map data corresponding to the first location and the table information. The server 200 may acquire the second target score corresponding to the second location based on the second map data corresponding to the second location and the table information.

The second target score may be described as a second type of target score or a second type of sub-score. Since there are the second target scores corresponding to each location, the second target score may include a plurality of concepts.

The server 200 may identify the target location based on at least one of the first target score or the second target score (S633).

According to an embodiment, the server 200 may identify the target location based on the first target score.

According to an embodiment, the server 200 may identify the target location based on the second target score.

According to one embodiment, the server 200 may identify the target location based on the first target score and the second target score.

The type of target score used to identify the target location may change depending on the user's settings.

When the target location is identified, the server 200 may transmit the target location to the movable robot 100 (S640), and the movable robot 100 may store the target location (S650).

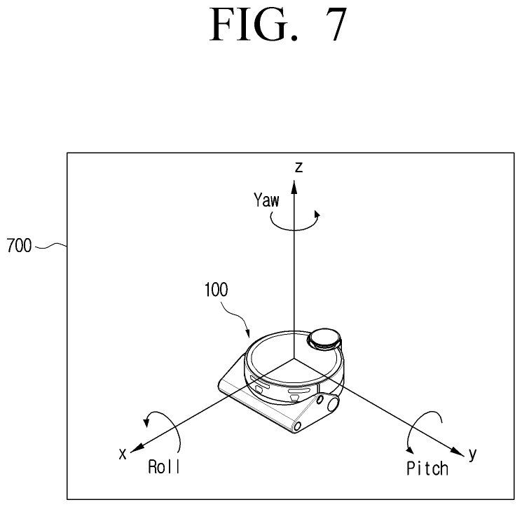

FIG. 7 is a diagram for describing coordinate axes according to an embodiment.

A coordinate system 700 in FIG. 7 indicates an x-axis, a y-axis, and a z-axis based on the moving direction of the movable robot 100. Rotation about the x-axis may be defined as roll, rotation about the y-axis may be defined as pitch, and rotation about the z-axis may be defined as yaw. The x-axis may be described as a first axis, the y-axis may be described as a second axis, and the z-axis may be described as a third axis. Regarding the rotation direction of the roll, pitch, and yaw, a clockwise direction may be a positive number and a counterclockwise direction may be a negative number, based on the direction looking at each axis from the origin.

FIG. 8 is a diagram for describing a table for calculating a target score according to an embodiment.

Referring to FIG. 8, the server 200 may include table information 810 and 820 for comparing data to acquire a target score.

The first table information 810 may be used to acquire the target score corresponding to the sensing data. The first table information 810 may include at least one of a first table 811 used to acquire target scores corresponding to ultrasonic data, a second table 812 used to acquire target scores corresponding to gyro data, a third table 813 used to acquire target scores corresponding to optical data, a fourth table 814 used to acquire target scores corresponding to image data.

The server 200 may identify the type of sensing data and identify a table corresponding to the identified type. The identified type may be at least one of ultrasonic data, gyro data, optical data, and image data.

For example, when the ultrasonic data is received, the server 200 may acquire target scores for each coordinate using the ultrasonic data and the first table 811.

For example, when the gyro data is received, the server 200 may acquire target scores for each coordinate using the gyro data and the second table 812.

For example, when the optical data is received, the server 200 may acquire target scores for each coordinate using the optical data and the third table 813.

For example, when the image data is received, the server 200 may acquire target scores for each coordinate using the optical data and the fourth table 814.

The target scores corresponding to each type may be written as sub-target scores.

The server 200 may use an object recognition model to analyze the image data. The object recognition model will be described with reference to FIG. 10.

There may be various ways to calculate the first target score acquired based on the sensing data. The server 200 may acquire one first target score by combining the sub-target scores acquired for each type.

As an example, the server 200 may acquire one first target score by adding up the target scores for each type.

As an example, the server 200 may acquire one first target score by reflecting weights for each type.

As an example, the server 200 may acquire an average value of target scores for each type as one first target score.

As an example, the server 200 may acquire a minimum value of target scores for each type as one first target score.

The second table information 820 may be used to acquire a second target score corresponding to the map data. The second table information 820 may include a fifth table used to acquire the second target score corresponding to characteristic data of specific coordinates.

The server 200 may acquire coordinate data and characteristic data included in the map data. The server 200 may acquire the second target scores for each coordinate based on the coordinate data, the characteristic data, and the fifth table 820.

The server 200 may determine a final target score based on at least one of the first target score or the second target score. The calculation method (summation, weight, average value, minimum value, etc.) of acquiring the first target score by combining the target scores for each type may be equally applied to the operation of combining the first target score and the second target score.

In FIG. 8, an embodiment in which a separate table exists for each type of sensing data is described. Depending on the implementation example, multiple types of sensing data may be grouped into one group. This will be described with reference to FIG. 9.

FIG. 9 is a diagram illustrating the table for calculating the target score according to an embodiment.

Referring to FIG. 9, the movable robot 100 may sense at least one of sensing data of a first group, sensing data of a second group, or map data.

The sensing data may vary depending on the type of sensor. The movable robot 100 or the server 200 may group sensing data into separate groups depending on the type of sensing data. For example, the movable robot 100 or the server 200 may divide the sensing data into the sensing data of the first group and the sensing data of the second group according to preset standards.

The sensing data of the first group may be data including at least one of the ultrasonic data, the gyro data, and the optical data. The movable robot 100 or the server 200 may identify a data group including at least one of the ultrasonic data, the gyro data, and the optical data as the sensing data of the first group.

The server 200 may store tables 910, 920, and 930 that map target scores corresponding to preset data.

The server 200 may store a first table 910 corresponding to the sensing data of the first group. The server 200 may acquire a target score corresponding to a specific location using the sensing data of the first group and the first table 910. The target score of the first group may be described as the first sub-target score.

The sensing data of the second group may include image data. The movable robot 100 or the server 200 may identify the data group including the image data as the sensing data of the second group.

The server 200 may store a second table 920 corresponding to the sensing data of the second group. The server 200 may acquire a target score corresponding to a specific location using the sensing data of the second group and the second table 920. The target score of the second group may be described as the second sub-target score.

There may be various ways to calculate the first target score acquired based on the sensing data. The server 200 may acquire one first target score by combining the sub-target scores acquired for each group.

As an example, the server 200 may acquire one first target score by adding up the target scores for each group.

As an example, the server 200 may acquire one first target score by reflecting weights for each group.

As an example, the server 200 may acquire an average value of target scores for each group as one first target score.

The movable robot 100 may transmit the map data to the server 200. The server 200 may acquire coordinate data included in the map data and feature data corresponding to the coordinate data. The server 200 may acquire the second target score using the coordinate data, the feature data, and a third table 930.

FIG. 10 is a diagram for describing an object recognition operation according to an embodiment.

The server 200 may store an AI object recognition model 1000. The AI object recognition model 1000 may be a model that receives image data as input and identifies objects included in the image data. When the image data is acquired as input data, the AI object recognition model 1000 may output objects included in the image data as output data. The server 200 may input image data 1010, 1020, 1030, and 1040 to the AI object recognition model 1000, and acquire objects (TV, refrigerator, washing machine, air conditioner) corresponding to each of the image data 1010, 1020, 1030, and 1040 from the AI object recognition model 1000. The server 200 may store the object recognition information including the acquired objects.

The server 200 may acquire the target score corresponding to the image data using the object recognition information. For example, the server 200 may receive first image data including a washing machine captured at first coordinates, and input the first image data to the AI object recognition model 1000. The server 200 may acquire the object recognition information including the washing machine from the AI object recognition model 1000, and use the object recognition information (washing machine) and the fourth table 814 of FIG. 8 to calculate (or acquire) the target score of the first coordinates where the first image data is acquired as 10 points.

According to various embodiments, the movable robot 100 may receive a user input including a control command to separate the cleaning pad at a location corresponding to a preset object (e.g., a washing machine) while the cleaning traveling is performed. The movable robot 100 may use the AI object recognition model 1000 to analyze a preset object included in the control command. The movable robot 100 may identify the preset object based on the user input even if the target location has been pre-stored (or identified). The AI object recognition model 1000 may be used to identify the preset object. When the preset object is identified based on the image data sensed by the movable robot 100, the target location may be identified (or changed to) as the location corresponding to the preset object.

FIG. 11 is a diagram for describing an operation of identifying a target location using the first terminal device 300-1 according to an embodiment.

Referring to FIG. 11, the movable robot 100 may acquire the map data (S1110). The movable robot 100 may transmit the map data to the server 200 (S1120).

The server 200 may receive the map data from the movable robot 100. The server 200 may store the map data (S1131).

According to the user command for setting the target location, the first terminal device 300-1 may provide a first guide UI.

The first terminal device 300-1 may provide the first guide UI for identifying the target location (S1132). The first terminal device 300-1 may provide a current location. The first terminal device 300-1 may include a display or a speaker. The first guide UI may include a UI for specifying the current location. The screen related to the first guide UI is illustrated in FIG. 12. For example, the first terminal device 300-1 may be a user's smartphone.

Providing the guide UI may include at least one of an operation of displaying guide information through a display or an operation of outputting guide information through a speaker.

The first terminal device 300-1 may receive the user input for specifying the current location through the first guide UI (S1133). The user input may include voice input or manipulation input. The first terminal device 300-1 may acquire the user input including voice through the microphone. The first terminal device 300-1 may acquire the user input including the manipulation input through the manipulation interface. The manipulation may include on operation of a user selecting a specific button or touching a specific location.

The first terminal device 300-1 may transmit the current location of the first terminal device 300-1 corresponding to the user input to the server 200 (S1134). The first terminal device 300-1 may be connected to the server 200. The first terminal device 300-1 may communicate with the server 200 based on a preset communication method.

The server 200 may receive the current location of the first terminal device 300-1 from the first terminal device 300-1. When the current location of the first terminal device 300-1 is identified, the server 200 may identify the target location based on the current location and map data of the first terminal device 300-1 (S1135). The server 200 may determine the current location of the first terminal device 300-1 when the user input is received as the target location.

The server 200 may transmit the target location to the movable robot 100 (S1140). The movable robot 100 may be connected to the server 200 using the preset communication method.

The movable robot 100 may receive the target location from the server 200. The movable robot 100 may store the target location (S1150).

FIG. 12 is a diagram for describing a guide screen for identifying the target location using the first terminal device 300-1 according to an embodiment.

A guide screen 1200 of FIG. 12 may be a screen corresponding to the first guide UI of FIG. 11. The guide screen 1200 may include at least one of a UI 1210 for guiding user input, a UI 1220 for selecting a target location, a UI 1230 for guiding voice input, a UI 1240 for guiding the location of the first terminal device 300-1, and a UI 1250 for indicating the location of the first terminal device 300-1.

The UI 1210 for guiding the user input may include at least one of information that directly guides the user to move to the target location to set the target location and information that guides the user input at the target location.

The UI 1220 for selecting the target location may include a UI for a user to directly input the manipulation input at the target location.

The UI 1230 for guiding the voice input may include information guiding that the target location may be selected by voice rather than by the manipulation input through the UI 1220.

The UI 1240 for guiding the location of the first terminal device 300-1 may include information indicating that the location of the first terminal device 300-1 may be directly confirmed in the UI 1250.

The UI 1250 indicating the location of the first terminal device 300-1 may include a map of the space where the movable robot 100 is traveling (or is scheduled to travel) and the location of the first terminal device 300-1 displayed on the map.

Through the UI 1250, the user may confirm in real time where the first terminal device 300-1 is currently located.

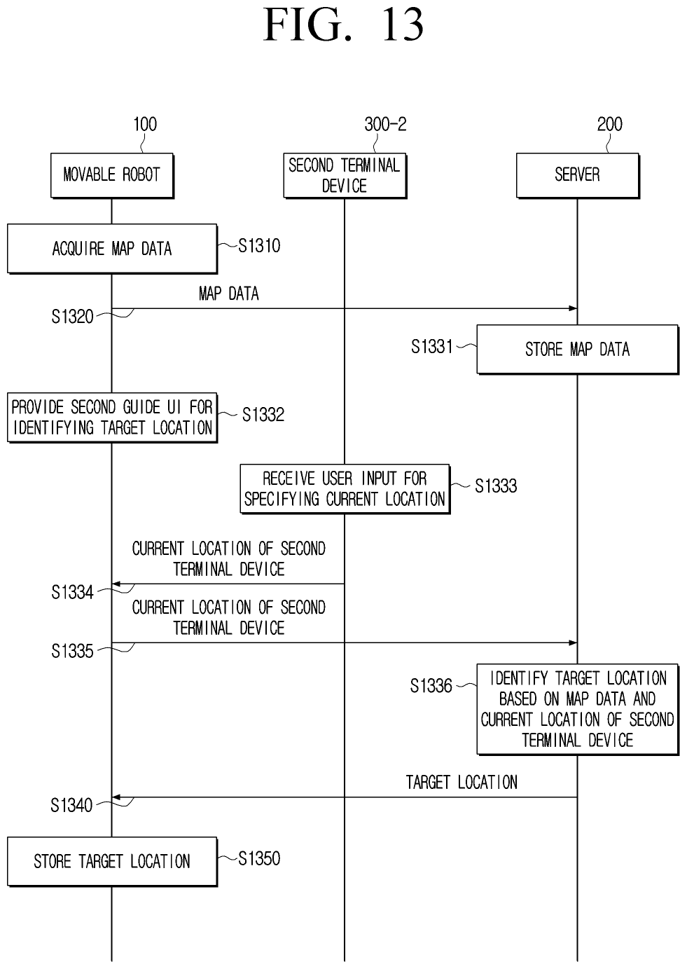

FIG. 13 is a diagram for describing an operation of identifying a target location using the second terminal device 300-2 according to an embodiment.

Steps S1310, S1320, S1331, S1340, and S1350 in FIG. 13 may correspond to steps S1110, S1120, S1131, S1140, and S1150 in FIG. 11. Redundant descriptions will be omitted.

The movable robot 100 may provide a second guide UI for identifying the target location according to a user command (S1332). The second guide UI may include information guiding the target location to be specified through the second terminal device 300-2.

For example, the second guide UI may include information indicating “Please move the second terminal device 300-2 to the target location and press the button on the second terminal device 300-2.” The movable robot 100 may output the guide information through the speaker. The second terminal device 300-2 may be a smart tag device.

The second terminal device 300-2 may receive the user input for specifying the current location (S1333). The user input may be the manipulation input or the voice input. When the smart tag does not include the microphone, the user may specify the current location of the second terminal device 300-2 by pressing the button on the second terminal device 300-2. When the user input is received, the second terminal device 300-2 may transmit the current location of the second terminal device 300-2 to the movable robot 100 (S1334).

The movable robot 100 may receive the current location of the second terminal device 300-2 from the second terminal device 300-2. The movable robot 100 may transmit the current location of the second terminal device 300-2 to the server 200 (S1335).

The server 200 may receive the current location of the second terminal device 300-2 from the movable robot 100. The server 200 may identify the target location based on the map data and the current location of the second terminal device 300-2 (S1336). The server 200 may determine the current location of the second terminal device 300-2 when the user input is received as the target location.

The server 200 may transmit the target location to the movable robot 100 (S1340), and the movable robot 100 may store the target location (S1350).

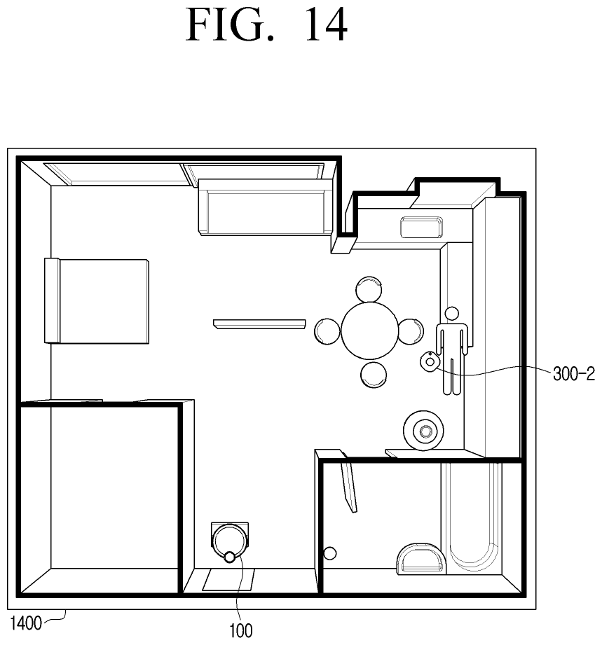

FIG. 14 is a diagram for describing an example of identifying the target location using the second terminal device 300-2 according to an embodiment.

FIG. 14 (1400) may illustrate an example in which the user directly carries the second terminal device 300-2 and moves to the target location. At the target location, the user may press a specific button on the second terminal device 300-2. The second terminal device 300-2 may transmit the current location when the user input is received to the movable robot 100.

FIG. 15 is a diagram for describing an operation of identifying the target location using the first terminal device 300-1 and the second terminal device 300-2 according to an embodiment.

Steps S1510, S1520, S1531, S1540, and S1550 in FIG. 15 may correspond to steps S1110, S1120, S1131, S1140, and S1150 in FIG. 11. Redundant descriptions will be omitted.

According to the user command, the first terminal device 300-1 may provide a third guide UI for identifying the target location (S1532). The third guide UI may include may include information guiding the target location to be specified through the second terminal device 300-2. In the embodiment of FIG. 15, an entity (first terminal device 300-1) that displays the guide information and an entity (second terminal device 300-2) that specifies the target location may be different. The third guide UI is described with reference to FIG. 16.

After the third guide UI is provided, the second terminal device 300-2 may receive the user input for specifying the current location (S1533). The second terminal device 300-2 may transmit the current location of the second terminal device 300-2 to the first terminal device 300-1 (S1534). The first terminal device 300-1 may transmit the current location of the second terminal device 300-2 to the server 200 (S1535).

According to various embodiments, the second terminal device 300-2 may transmit the current location of the second terminal device 300-2 to the movable robot 100. The movable robot 100 may transmit the current location of the second terminal device 300-2 to the server 200.

The server 200 may receive the current location of the second terminal device 300-2 from the first terminal device 300-1. The server 200 may identify the target location based on the map data and the current location of the second terminal device 300-2 (S1536).

The server 200 may transmit the target location to the movable robot 100 (S1540), and the movable robot 100 may store the target location (S1550).

FIG. 16 is a diagram for describing a guide screen for identifying the target location using the first terminal device 300-1 and the second terminal device 300-2 according to an embodiment.

A guide screen 1600 of FIG. 16 may be a screen corresponding to the third guide UI of FIG. 15. The guide screen 1600 may include at least one of a UI 1610 for guiding the manipulation of the second terminal device 300-2 at the target location, a UI 1620 for guiding the voice input, a UI 1630 for guiding the location of the second terminal device 300-2, and a UI 1640 for indicating the location of the second terminal device 300-2.

The UI 1610 that guides the manipulation of the second terminal device 300-2 at the target location is information that guides the user to move directly to the target location to set the target location, and information that guides the user input at the target location using the second terminal device 300-2.

The UI 1620 for guiding the voice input may include the information guiding that the target location may be selected by voice.

The UI 1630 for guiding the location of the second terminal device 300-2 may include information indicating that the location of the second terminal device 300-2 may be directly confirmed in the UI 1640.

The UI 1640 for indicating the location of the second terminal device 300-2 may include a map of the space where the movable robot 100 is traveling (or is scheduled to travel) and the location of the second terminal device 300-2 displayed on the map.

Through the UI 1640, the user may confirm in real time where the second terminal device 300-2 is currently located.

FIG. 17 is a diagram for describing an operation of the user directly identifying the target location using the first terminal device 300-1 according to an embodiment.

Steps S1710, S1720, S1731, S1740, and S1750 in FIG. 17 may correspond to steps S1110, S1120, S1131, S1140, and S1150 in FIG. 11. Redundant descriptions will be omitted.

According to the user command, the first terminal device 300-1 may provide a fourth guide UI for identifying the target location (S1732). The fourth guide UI may include the UI for selecting the target location by the user. In the embodiment of FIG. 11, the user should directly move the first terminal device 300-1 to the target location. In the embodiment of FIG. 17, the user does not need to move to the target location with the first terminal device 300-1.

The first terminal device 300-1 may acquire the user input through the fourth guide UI (S1733). The first terminal device 300-1 may receive the user input for specifying the target location through the fourth guide UI. The first terminal device 300-1 may transmit the target location to the server 200 (S1734).

The server 200 may receive the target location from the first terminal device 300-1. The server 200 may store the target location (S1735). The server 200 may transmit the target location to the movable robot 100 (S1740), and the movable robot 100 may store the target location (S1750).

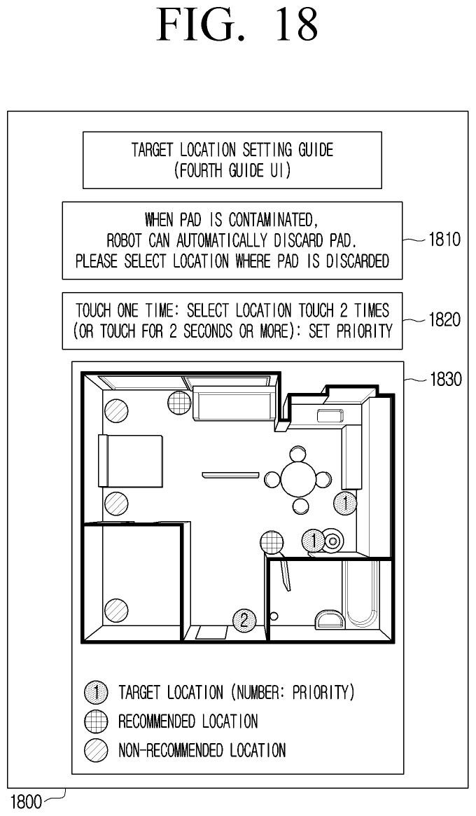

FIG. 18 is a diagram for describing a guide screen of the user directly identifying the target location using the first terminal device 300-1 according to an embodiment.

A guide screen 1800 of FIG. 18 may be a screen corresponding to the fourth guide UI of FIG. 17. The guide screen 1800 may include at least one of a UI 1810 for describing the target location, a UI 1820 for describing a method of selecting the target location, and a UI 1830 for indicating the target location.

The UI 1810 for explaining the target location may include a reason why the target location is to separate the cleaning pad and information indicating that the target location is set to discard the separated cleaning pad.

The UI 1820 for describing a method of selecting a target location may include at least one of a detailed method for determining the target location and a priority setting method.

When the user input for selecting the first location among candidate locations displayed on the UI 1830 is received once, the first terminal device 300-1 may determine the selected location as the target location.

When the user input for selecting the second location is received while the first location is selected as the target location, the first terminal device 300-1 may identify both the first location and the second location as the target location. There may be a plurality of target locations.

When the user input for selecting the same first location twice is received within a critical time, the first terminal device 300-1 may set a priority for the first location. When the first location is selected twice while the existing target location is not set, the first terminal device 300-1 may identify the first location as a target location of a first priority.

When the user input selecting the same second location twice is received within the critical time while the first location is identified as the target location of the first priority, the first terminal device 300-1 may identify the second location as the target location of the second priority.

When the user input for selecting the same first location twice is received for the critical time while the first location of the first priority and the second location of the second priority are set as the target location, the first terminal device 300-1 selects the first location as the target location of the second priority. The first terminal device 300-1 may change the second position from the second priority to the first priority.

The UI 1830 indicating the target location may indicate at least one of a recommended location, a non-recommended location, and a target location. Each location may be provided as a different UI. The target location may be provided with priority information. For example, the target location and the priority information corresponding to the target location may be provided together.

According to various embodiments, the user input of selecting the same location twice within the critical time may be replaced with the user input of continuously pressing the same location during the critical time.

According to various embodiments, detailed operations described in FIG. 18 may be performed in the server 200.

FIG. 19 is a diagram for describing the operation of directly identifying the target location through the movable robot 100 according to an embodiment.

Steps S1910, S1920, S1931, S1940, and S1950 in FIG. 19 may correspond to steps S1110, S1120, S1131, S1140, and S1150 in FIG. 11. Redundant descriptions will be omitted.

The movable robot 100 may receive the user input to specify the current location (S1932).

As an example, the movable robot 100 may receive the voice input for specifying the current location through the microphone.

As an example, the movable robot 100 may receive the manipulation input to specify the current location. The movable robot 100 may receive the manipulation input through the manipulation interface (e.g., a button) included in the movable robot 100. The movable robot 100 may receive the manipulation input through a remote control device connected to the movable robot 100. The remote control device may be connected to the movable robot 100 in a preset manner (e.g., Bluetooth, Wi-Fi, infrared, etc.).

The movable robot 100 may transmit the current location of the movable robot 100 to the server 200 (S1933).

The server 200 may receive the current location of the movable robot 100. The server 200 may identify the target location based on the map data and the current location of the movable robot 100 (S1934).

The server 200 may transmit the target location to the movable robot 100 (S1940), and the movable robot 100 may store the target location (S1950).

FIG. 20 is a diagram for describing an example of directly identifying the target location through the movable robot 100 according to an embodiment.

Referring to an example 2010 of FIG. 20, a user may utter a voice command to specify the current location of the movable robot 100. For example, the voice command may include “Store a current location as a location where the cleaning pad is discarded.” The movable robot 100 may record the user voice through the microphone and determine that a preset command has been identified in the recorded user voice. The movable robot 100 may transmit the current location of the movable robot 100 when the user command is received to the server 200.

Referring to an example 2020 of FIG. 20, the user may specify the current location by directly pressing the manipulation interface (e.g., a specific button) of the movable robot 100. When the manipulation input for selecting the preset button is received, the movable robot 100 may transmit the current location to the server 200 when the user input is received. The manipulation input may include an input for pressing the preset button for the critical time or more.

FIG. 21 is a diagram for describing an operation of separating a cleaning pad during the cleaning traveling according to an embodiment.

Referring to FIG. 21, the movable robot 100 may acquire the map data (S2110). The movable robot 100 may store the target location (S2120). According to the implementation example, step S2120 may be omitted.

The movable robot 100 may perform the cleaning traveling (S2130). The movable robot 100 may determine whether the preset event is identified during the cleaning traveling (S2135).

The preset event may indicate the preset event of the first group. The preset event of the first group may include at least one of an event in which a contamination level of the cleaning pad is identified as being equal to or greater than a threshold, an event in which a user command for replacing the cleaning pad is received, or an event in which the cleaning function is identified as being completed.

When the preset event of the first group is identified (S2135-Y), the movable robot 100 may identify the target location (S2140).

As an example, the movable robot 100 may identify (or acquire) the target location stored in step S2120.

As an example, the movable robot 100 may identify a new target location. The method for identifying the location target is described with reference to FIGS. 5 to 20.

When the location target is identified, the movable robot 100 may move to the target location (S2145). While moving to the target location, the movable robot 100 may determine whether an immovable event is identified (S2150).

The immovable event may indicate the preset event of the second group. The preset event of the second group may include at least one of an event in which an obstacle is identified, an event identified as passing through a prohibited area to move to the target location, an event in which the previously discarded cleaning pad is identified as being in the target location, and an event in which remaining power is identified as being insufficient to move to the target location.

When the immovable event is identified while moving to the target location (S2150—Y), the movable robot 100 may identify whether another target location exists (S2155). Another target location may indicate other target locations of lower priority (or equal priority) when the plurality of target locations exist.

When another location target is identified (S2155—Y), the movable robot 100 may move to another target location (S2145). The movable robot 100 may re-perform step S2150.

When another target location does not exist (S2155—N), the movable robot 100 may move to the charging location (S2165). The charging location may be described in expressions such as a standby location or the second target location. The existing target location (the location where the cleaning pad is discarded) may be described as the first target location.

When the immovable event is not identified while moving to the target location (S2150—N), the movable robot (100) may move to the target location and separate the cleaning pad (S2160). After separating the cleaning pad, the movable robot 100 may move to the charging location (S2165).

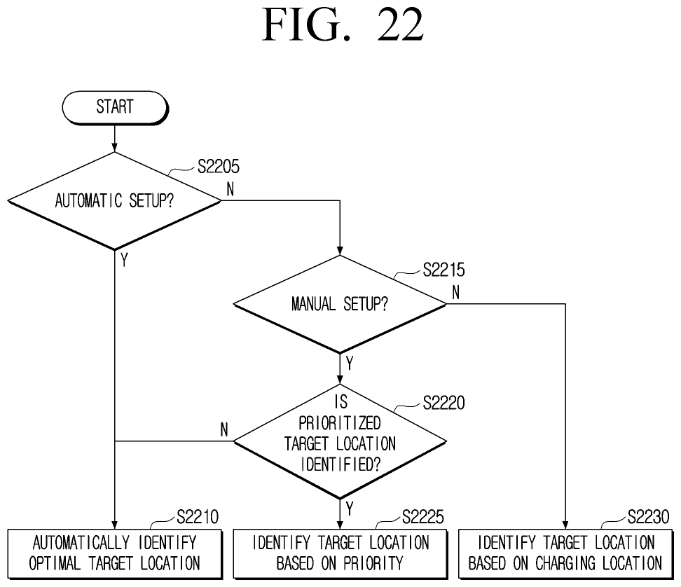

FIG. 22 is a diagram for describing various operations of identifying the target location according to an embodiment.

The operation of FIG. 22 may specify step S2140 in FIG. 21. When the preset event of the first group is identified during the cleaning traveling, the movable robot 100 may identify whether the target location should be automatically set (S2205). The method of setting the target location may change depending on the user's settings.

The movable robot 100 may determine whether the target location of the movable robot 100 is currently applied in an automatic setting mode or a manual setting mode.

When the target location is identified as being determined by automatic setting (S2205—Y), the movable robot 100 may automatically identify the optimal target location (S2210). The target location identified in step S2210 may be a step of identifying the target location determined by the server 200.

As an example, the target location identified in step S2210 may include an operation of identifying the target location stored in step S2120 of FIG. 21.

For example, the target location identified in step S2210 may be a final target location determined according to a preset standard among the plurality of target locations. For example, a location with the highest user frequency, a location closest to the washing machine, a location closest to the user, a location closest to a specific object, etc., may be used as a standard for determining the final target location.

When the location target is not determined by the automatic setting (S2205—N), the movable robot 100 may determine whether the target location is identified by the manual setting (S2215). The movable robot 100 may determine whether the target location has been input by the user through the manual setting.

When the location target is set manually (S2215—Y), the movable robot 100 may identify whether the target location is a target location whose priority has been determined (S2220). The priority information may not be confirmed for the manually set target location.

For example, when only one target location is manually set, the movable robot 100 may determine that the target location whose priority has not been determined has been identified.

For example, when two or more target locations are manually set as first priority, the movable robot 100 may determine that the target location whose priority has not been determined has been identified.

When the target location whose priority has been determined is identified (S2220—Y), the movable robot 100 may identify the target location based on the priority (S2225). The movable robot 100 may identify the final target location based on the first target location of the first priority and the second target location of the second priority.

When the target location whose priority has not been determined is identified (S2220—N), the movable robot 100 may automatically identify the final target location according to the preset standard (S2210). The preset standard may be changed depending on the user's settings.

When the target location is not identified even through the automatic setting and the manual setting (S2215—N), the movable robot (100) may identify the target location based on the charging location (S2230).

As an example, the movable robot 100 may identify the target location like the charging location.

As an example, the movable robot 100 may identify a location within a critical distance from the charging location as the target location.

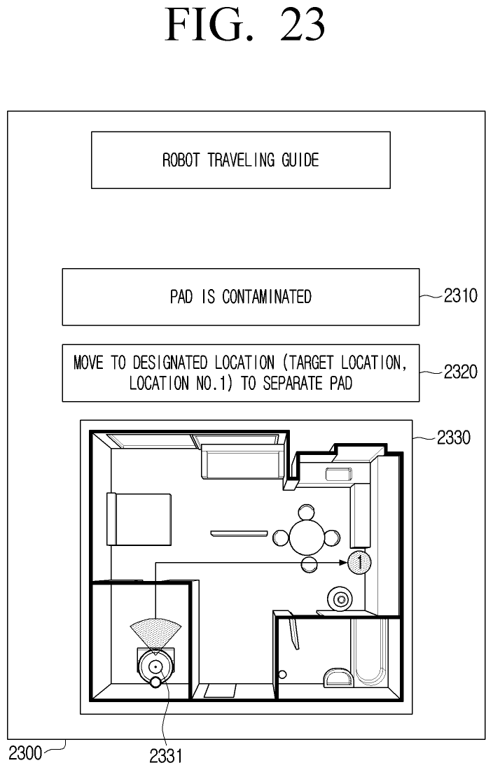

FIG. 23 is a diagram for describing a screen that guides an operation of separating the cleaning pad according to an embodiment.

A screen 2300 of FIG. 23 may be a screen displayed when the preset event of the first group of FIG. 21 occurs. When it is identified that the preset event of the first group in FIG. 21 has occurred, the first terminal device 300-1 may provide the screen 2300.

The screen 2300 may include at least one of a UI 2310 indicating that the preset event has been identified, a UI 2320 indicating the operation corresponding to the preset event, and a UI 2330 indicating the location movement.

The UI 2310 indicating that the preset event has been identified may include information indicating a notification of the occurrence of the preset event. For example, the UI 2310 may include at least one of text information or image information indicating the occurrence of the cleaning pad contamination.

The UI 2320 indicating the operation corresponding to the preset event may include text information describing the function corresponding to the preset event. For example, the UI 2320 may include at least one of the information indicating the target location and the information indicating moving to the target location.

The UI 2330 indicating the location movement may include at least one of the movement path of the movable robot 100, the target location, and the priority of the target location. For example, the UI 2330 may include a map where the movable robot 100 exists and a target location on the map.

The UI 2330 may include a UI 2331 indicating that the movable robot 100 is attaching the cleaning pad.

FIG. 24 is a diagram for describing a screen that guides an operation performed after separating the cleaning pad according to an embodiment.

A screen 2400 of FIG. 24 may be a screen displayed after performing an operation corresponding to the preset event of FIG. 23. The screen 2400 may include at least one of a UI 2410 indicating that the operation corresponding to the preset event has been completed, a UI 2420 indicating the operation performed after completion, and a UI 2430 indicating the location movement.

The UI 2410 indicating that the operation corresponding to the preset event has been completed may include at least one of text information or image information indicating that the operation corresponding to the occurrence of the preset event of the first group has been completed. For example, the UI 2410 may include at least one of the text information or the image information indicating that the cleaning pad has been separated.

The UI 2420 indicating the operation performed after completion may include the text information indicating the operation performed after the operation corresponding to the preset event is completed. For example, the UI 2420 may include the information about moving to the charging location after separating the cleaning pad from the target location.

The UI 2430 indicating the location movement may include the movement path of the movable robot 100 and the next destination location. For example, the UI 2430 may include the map where the movable robot 100 exists and the charging location on the map.

The UI 2430 may include a UI 2431 indicating that the cleaning pad is separated from the target location. When the cleaning pad is removed from the target location by the user, the UI 2431 may not be displayed.

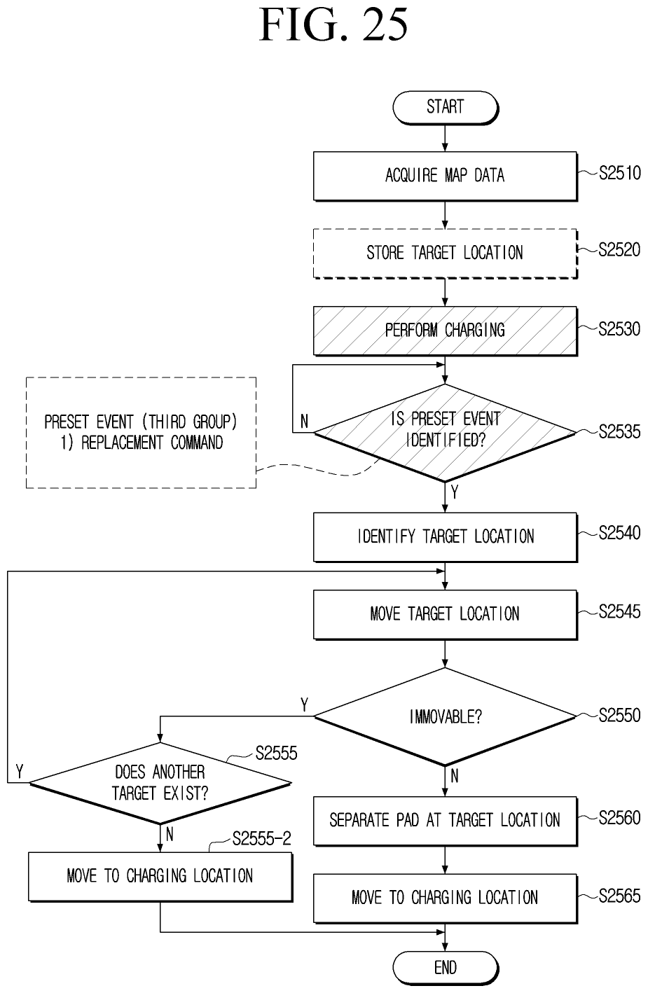

FIG. 25 is a diagram for describing the operation of separating the pad during charging according to an embodiment.

Steps S2510, S2520, S2540, S2545, S2550, S2555, S2560, and S2565 in FIG. 25 may correspond to steps S2110, S2120, S2140, S2145, S2150, S2155, S2160, and S2165 in FIG. 21. Redundant descriptions will be omitted.

The movable robot 100 may perform the charging (S2530). While charging, the movable robot 100 may determine whether the preset event of the third group is identified (S2535).

The preset event of the third group may include an event of receiving a user command to replace the cleaning pad. When it is identified that a preset event of the third group has occurred (S2535—Y), the movable robot 100 may perform steps S2540, S2545, S2550, S2555, S2560, and S2565.

When the movable robot 100 may not move to the target location and there is no other target location, the movable robot 100 may move directly to the charging location (S2555-2).

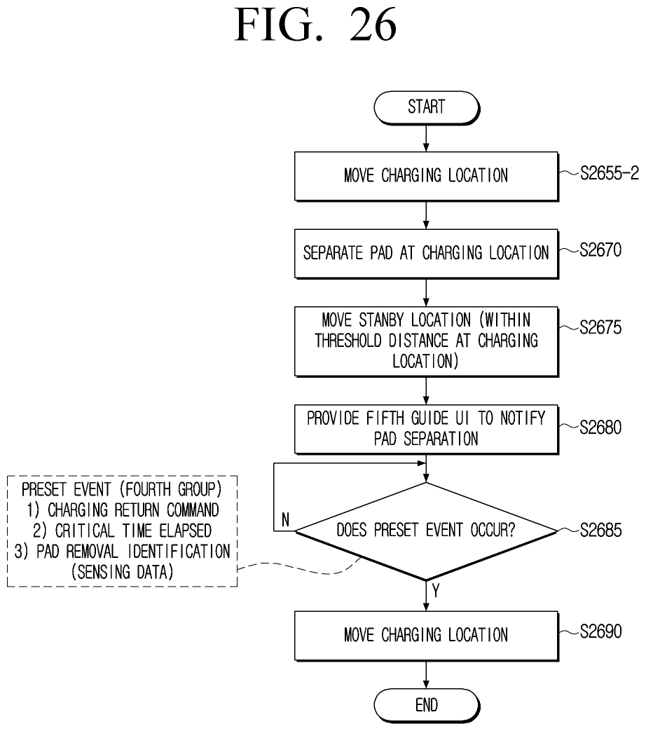

FIG. 26 is a diagram for describing an operation of returning to the charging location after separating the cleaning pad during charging according to an embodiment.

Step S2655-2 in FIG. 26 may correspond to step S2555-2 in FIG. 25. It is assumed that the movable robot 100 cannot move to the target location or that the charging location and target location are the same.

The movable robot 100 may move to the charging location and separate the cleaning pad from the charging location (S2670). After removing the cleaning pad, the movable robot 100 may move to the standby location (S2675). The standby location may be located within a critical distance from the charging location.

The movable robot 100 may provide a fifth guide UI to notify the separation of the cleaning pad (S2680). The fifth guide UI may include information indicating that the cleaning pad separation operation has been completed. For example, the movable robot 100 may output information for notifying that the cleaning pad has been separated through the speaker.

After the fifth guide UI is provided, the movable robot 100 may identify whether the preset event of the fifth group has occurred (S2685). The preset event of the fifth group may include at least one of an event in which the user command to perform the charging is input, an event in which the critical time has elapsed from the point of moving to the standby location, and an event in which the cleaning pad separated from the charging location is not identified in the charging location.

The movable robot 100 may determine whether the cleaning pad has been removed from the charging location by acquiring the sensing data. For example, the movable robot 100 may acquire the image data and determine whether the cleaning pad has been removed from the charging location.

When it is identified that a preset event of a fifth group has occurred (S2685—Y), the movable robot 100 may move to the charging location (S2690).

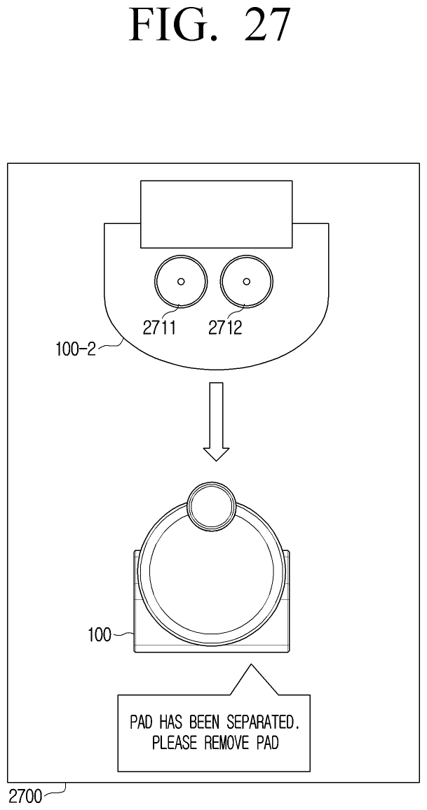

FIG. 27 is a diagram for describing an example of returning to the charging location after separating the cleaning pad during the charging according to an embodiment.

The embodiment 2700 of FIG. 27 may represent an example of providing the fifth guide UI of FIG. 26. The movable robot 100 may be charged at a charging station 100-2. The movable robot 100 may separate cleaning pads 2711 and 2712 from the charging station 100-2 and move to the standby location.

After moving to the standby location, the movable robot 100 may output the fifth guide UI. For example, the fifth guide UI may include at least one of the information indicating that the cleaning pad has been removed or the information guiding the user to remove the cleaning pad.

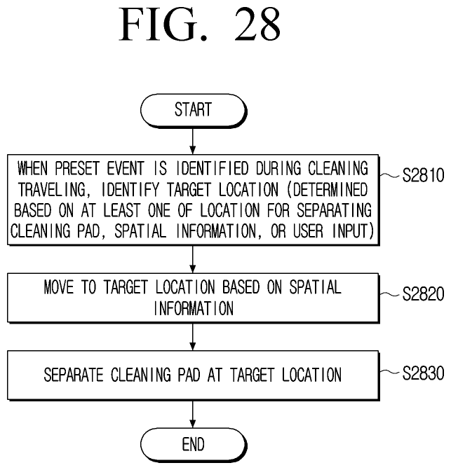

FIG. 28 is a diagram for describing a controlling method of the movable robot 100 according to an embodiment.

Referring to FIG. 28, the controlling method of the movable robot 100 that stores the spatial information and the target location for separating the cleaning pad includes identifying the target location when the preset event is identified during the cleaning traveling (S2810), moving to the target location based on the spatial information (S2820), and separating the cleaning pad from the target location (S2830), and the target location is determined based on at least one of the spatial information or the user input.

The preset event may include at least one of an event in which a contamination level of the cleaning pad is identified as being equal to or greater than a threshold, an event in which a user command for replacing the cleaning pad is received, or an event in which the cleaning traveling is identified as being completed.

The target location is determined based on the sensing data and the map data included in the spatial information, and the controlling method may further include acquiring the sensing data through the sensing unit.

The sensing unit may include at least one of the ultrasonic sensor, the gyro sensor, the optical sensor, and the image sensor, and the sensing data may include at least one of the ultrasonic data, the gyro data, the optical data, and the image data.

The target location may be determined based on the object recognition information identified based on the image data.

The movable robot 100 may be connected to a first terminal device, and the target location may be determined based on the user input received through a guide UI provided by the first terminal device.

The preset event is a preset event of a first group, the target location is a first target location, and the controlling method may further include identifying a second target location that is different from the first target location when a preset event of a second group is identified while moving to the target location and moving to the second target location based on the spatial information.

The preset event of the second group includes at least one of an event in which an obstacle is identified, an event identified as passing through a prohibited area to move to the first target location, an event in which a separated cleaning pad is identified as being in the first target location, and an event in which remaining power is identified as being insufficient to move to the first target location.

When the second target location that is different from the first target location is not identified, the controlling method may further include moving to a charging location based on the spatial information.

The controlling method may further include providing a UI for notifying that the cleaning pad is separated when the cleaning pad is separated from the target location.

Meanwhile, the methods according to various embodiments of the disclosure described above may be implemented in the form of an application that may be installed in an existing electronic apparatus (movable robot).

In addition, the methods according to various embodiments of the disclosure described above may be implemented only by software upgrade or hardware upgrade for the existing electronic apparatus (movable robot).

Further, various embodiments of the disclosure described above may also be performed through an embedded server included in the electronic apparatus (movable robot) or an external server of at least one of the electronic apparatus (movable robot) or the display apparatus.

According to an embodiment of the disclosure, the diverse embodiments described above may be implemented as software including instructions stored in a machine-readable storage medium (e.g., a computer-readable storage medium). A machine may be an apparatus that invokes the stored instruction from the storage medium and may operate according to the invoked instruction, and may include the electronic apparatus (movable robot) according to the disclosed embodiments. When a command is executed by the processor, the processor may directly perform a function corresponding to the command or other components may perform the function corresponding to the command under a control of the processor. The command may include codes created or executed by a compiler or an interpreter. The storage medium readable by the machine may be provided in the form of a non-transitory storage medium. Here, the term ‘non-transitory’ means that the storage medium is tangible without including a signal, and does not distinguish whether data are semi-permanently or temporarily stored in the storage medium.

In addition, according to an embodiment of the disclosure, the methods according to the diverse embodiments described above may be included and provided in a computer program product. The computer program product may be traded as a product between a seller and a purchaser. The computer program product may be distributed in the form of a storage medium (e.g., a compact disc read only memory (CD-ROM)) that may be read by the machine or online through an application store (e.g., PlayStore™). In a case of the online distribution, at least portions of the computer program product may be at least temporarily stored in a storage medium such as a memory of a server of a manufacturer, a server of an application store, or a relay server or be temporarily created.

Each of components (for example, modules or programs) according to the diverse embodiments may include a single entity or a plurality of entities, and some of the corresponding sub-components described above may be omitted or other sub-components may be further included in the diverse embodiments. Alternatively or additionally, some of the components (e.g., the modules or the programs) may be integrated into one entity, and may perform functions performed by the respective corresponding components before being integrated in the same or similar manner. Operations performed by the modules, the programs, or other components according to the diverse embodiments may be executed in a sequential manner, a parallel manner, an iterative manner, or a heuristic manner, at least some of the operations may be performed in a different order or be omitted, or other operations may be added.

Although embodiments of the disclosure have been illustrated and described hereinabove, the disclosure is not limited to the abovementioned specific embodiments, but may be variously modified by those skilled in the art to which the disclosure pertains without departing from the gist of the disclosure as disclosed in the accompanying claims. These modifications should also be understood to fall within the scope and spirit of the disclosure.

1. A movable robot, comprising:
a driver; and
at least one processor configured to:
when a preset event is identified during cleaning traveling of the movable robot, identify a target location stored in a memory for separating a cleaning pad from the movable robot,
control the driver to move the movable robot to the identified target location based on spatial information stored in the memory, and
control the movable robot to separate the cleaning pad from the movable robot at the identified target location,
wherein the identified target location is determined based on at least one of the spatial information or user input.

2. The movable robot of claim 1, wherein
the preset event includes at least one of an event in which a contamination level of the cleaning pad is identified as being greater than a threshold, an event in which a user command for replacing the cleaning pad is received, or an event in which the cleaning traveling is identified as being completed.

3. The movable robot of claim 1, wherein
the identified target location is determined based on sensing data and map data included in the spatial information, and
the at least one processor acquires the sensing data through a sensing unit.

4. The movable robot of claim 3, wherein
the sensing unit includes at least one of an ultrasonic sensor, a gyro sensor, an optical sensor, or an image sensor, and
the sensing data includes at least one of ultrasonic data, gyro data, optical data, or image data.

5. The movable robot of claim 4, wherein
the identified target location is determined based on object recognition information identified based on the image data.

6. The movable robot of claim 1, further comprising:
a communication interface configured to connect to a first terminal device,
wherein the identified target location is determined based on the user input received through a guide user interface (UI) provided by the first terminal device.

7. The movable robot of claim 1, wherein
the preset event is a preset event of a first group,
the identified target location is a first target location, and
when a preset event of a second group is identified while the movable robot is moving to the first target location, the at least one processor is configured to:
identify a second target location stored in the memory that is different from the first target location, and
control the driver to move the movable robot to the second target location based on the spatial information.

8. The movable robot of claim 7, wherein
the preset event of the second group includes at least one of an event in which an obstacle is identified, an event identified as passing through a prohibited area to move the movable robot to the first target location, an event in which a separated cleaning pad is identified as being in the first target location, or an event in which remaining power of the movable robot is identified as being insufficient to move the movable robot to the first target location.

9. The movable robot of claim 7, wherein
when the second target location that is different from the first target location is not identified, the at least one processor is configured to control the driver to move the movable robot to a charging location based on the spatial information.

10. The movable robot of claim 1, wherein
when the cleaning pad is separated from the movable robot at the identified target location, the at least one processor is configured to provide a user interface (UI) for notifying that the cleaning pad is separated.

11. A method of controlling a movable robot including a driver, the method comprising:
when a preset event is identified during cleaning traveling of the movable robot, identifying a target location stored in a memory for separating a cleaning pad from the movable robot;
controlling the driver to move the movable robot to the identified target location based on spatial information stored in the memory; and
controlling the movable robot to separate the cleaning pad from the movable robot at the identified target location,
wherein the identified target location is determined based on at least one of the spatial information or user input.

12. The method of claim 11, wherein
the preset event includes at least one of an event in which a contamination level of the cleaning pad is identified as being greater than a threshold, an event in which a user command for replacing the cleaning pad is received, or an event in which the cleaning traveling is identified as being completed.

13. The method of claim 11, wherein
the identified target location is determined based on sensing data and map data included in the spatial information, and
the method further comprises:
acquiring the sensing data through a sensing unit.

14. The method of claim 13, wherein
the sensing unit includes at least one of an ultrasonic sensor, a gyro sensor, an optical sensor, or an image sensor, and
the sensing data includes at least one of ultrasonic data, gyro data, optical data, or image data.

15. The method of claim 14, wherein
the identified target location is determined based on object recognition information identified based on the image data.
